(19) United States
(12) Patent Application Publication
(10) Pub. No.: US 2019/0333255 A1
(43) Pub. Date: Oct. 31, 2019

(54) SYSTEM AND METHOD FOR STATIONARY GANTRY COMPUTED TOMOGRAPHY (SGCT) IMAGE RECONSTRUCTION

(71) Applicants: University of Central Florida Research Foundation, Inc., Orlando, FL (US); iTomography Corporation, Barker, TX (US)

(72) Inventors: Alexander Katsevich, Oviedo, FL (US); Michael Frenkel, Barker, TX (US)

(21) Appl. No.: 16/397,652

(22) Filed: Apr. 29, 2019

Related U.S. Application Data
(60) Provisional application No. 62/663,802, filed on Apr. 27, 2018.

(51) Int. Cl. G06T 11/00; G01N 23/046

(52) U.S. Cl. CPC G06T 11/008; G06T 11/006; G01N 23/046; G06T 2211/416; G01N 2223/419; G06T 2211/432; G01N 2223/401; G01N 2223/413; G06T 2211/421

(57) ABSTRACT

A system and method for performing reconstruction of an image of an object from tomographic data collected by a scanner having stationary x-ray sources and stationary x-ray detectors. The system and method utilize a weighting function based upon a source availability map to establish a no-view differentiation condition, thereby reducing artifacts in the reconstructed image of the object.

### CROSS-REFERENCE TO RELATED APPLICATIONS

This application claims priority to U.S. Provisional Patent Application No. 62/663,802 entitled, “System and Method for Stationary Gantry Computed Tomography (CT) Image Reconstruction”, filed on Apr. 27, 2018, which is incorporated herein by reference in its entirety.

### BACKGROUND OF THE INVENTION

The subject matter disclosed herein relates generally to systems and methods for x-ray imaging. More particularly, the subject matter disclosed herein relates to non-rotating, stationary gantry and methods for imaging a subject or object of interest. X-ray imaging is widely used in many areas including medical diagnostics and treatment, industrial inspection and testing and security screening, such as luggage screening at airports.

Stationary Gantry Computed Tomography (SGCT) systems exhibit features that are typically not present in more conventional scanners. In an SGCT system, the relative position of the source and the detector change depending upon the location of the source. Additionally, SGCT systems may have a ring of sources that are fired non-sequentially, which leads to the absence of “source trajectory” in the conventional sense.

With Stationary Gantry CT systems, it is impossible to collect complete tomographic data that is sufficient for theoretically exact reconstruction. In this case a typical approach to reconstruction is based on the appropriate generalization of the Feldkamp, Davis, Kress (FDK) algorithm. The key simplifying assumption in the FDK-type algorithms is that the object be z-independent. Here z is the axis of rotation understood in a general sense. The assumption of z-independence is frequently violated and leads to strong cone beam artifacts. These artifacts may lead to incorrectly reconstructed CT numbers, which, in turn, may lead to incorrect interpretation of the reconstructed CT images. One way to overcome this problem is by using an iterative reconstruction algorithm. This, however, is not practical in applications where high throughput and/or low computational load are required. Hence the need arises to come up with a more accurate reconstruction algorithm that is computationally efficient, reduces the cone beam artifact, and provides more accurate CT results.

Accordingly, what is need in the art is an improved system and method for image reconstruction that addresses the unique features present in SGCT-type systems.

### SUMMARY OF THE INVENTION

In various embodiments, the present invention provides an improved system and method for stationary gantry computed tomography (SGCT) image reconstruction. The present invention provides a novel No View Differentiation (NVD) algorithm, which can be applied to SGCT-type systems.

The family of reconstruction algorithms, in accordance with the various embodiments of the present invention, involve a flexible weight function. Although the algorithms use view differentiation, their mathematically equivalent formulations that are of the NVD type can be obtained by integrating by parts. Weight optimization in the reconstruction algorithms is also used to address SGCT-specific tasks that do not arise with conventional scanners.

In one embodiment, the present invention provides a computer-implemented method for reconstructing images from tomographic cone beam data, which includes receiving tomographic cone beam data of an object collected by a scanner, analyzing the tomographic cone beam data at each point of a plurality of reconstruction points, wherein the tomographic cone beam data comprises one or more deficiencies, selecting a weight function for a non-iterative image reconstruction algorithm that overcomes the one or more deficiencies in the tomographic cone beam data as related to the plurality of reconstruction points and applying the non-iterative image reconstruction algorithm using the selected weight function for each of the plurality of reconstruction points to reconstruct the image of the object from the tomographic cone beam data.

The one or more deficiencies addressed by present invention may be a result of irregular view sampling, variation in source noise, variation in local spatial resolution and variation due to non-periodic source trajectory. Additionally, the one or more deficiencies in the tomographic cone beam data are a result of a changing position of an x-ray source of the scanner relative to a position of an x-ray detector of the scanner during a scan of the object. The weight function is selected to overcome these deficiencies.

In an additional embodiment, the present invention provides an image reconstruction system for reconstructing images from tomographic cone beam data. The system includes at least one data processor for receiving tomographic cone beam data of an object collected by a scanner and for analyzing the tomographic cone beam data at each point of a plurality of reconstruction points, wherein the tomographic cone beam data comprises one or more deficient. The data processor is further for selecting a weight function for a non-iterative image reconstruction algorithm that overcomes the one or more deficiencies in the tomographic cone beam data as related to the plurality of reconstruction points and for applying the non-iterative image reconstruction algorithm using the selected weight function for each of the plurality of reconstruction points to reconstruct the image of the object from the tomographic cone beam data.

In another embodiment, the present invention provides one or more non-transitory computer-readable media having computer-executable instructions for performing a method of running a software program on a computing device for reconstructing images from tomographic cone beam data, the computing device operating under an operating system, the method including issuing instructions from the software program comprising, receiving tomographic cone beam data of an object collected by a scanner. The method further includes issuing instructions comprising, analyzing the tomographic cone beam data at each point of a plurality of reconstruction points, wherein the tomographic cone beam data comprises one or more deficiencies, selecting a weight function for a non-iterative image reconstruction algorithm that overcomes the one or more deficiencies in the tomographic cone beam data as related to the plurality of reconstruction points and applying the non-iterative image reconstruction algorithm using the selected weight function for each of the plurality of reconstruction points to reconstruct the image of the object from the tomographic cone beam data.

The present invention provides an improved system and method for image reconstruction that addresses the unique features present in SGCT-type systems. The freedom of choice in the weight function accommodates for the peculiarity of the SGCT scanners and improves the quality of the reconstructed images.

### BRIEF DESCRIPTION OF THE DRAWINGS

For a fuller understanding of the invention, reference should be made to the following detailed description, taken in connection with the accompanying drawings, in which:

FIG. 1 is an illustration of an image reconstruction system for a stationary or fixed gantry, in accordance with an embodiment of the present invention.

FIG. 2 is a flow diagram illustrating a no-view differentiation image reconstruction method, in accordance with an embodiment of the present invention.

FIG. 3 is a diagram illustration a pi-partner pair of the source trajectory that is used to calculate the weighting function, in accordance with an embodiment of the present invention.

FIG. 4 illustrates an image of the phantom used for 2D CT simulation, in accordance with an embodiment of the present invention.

FIG. 5a illustrates projected data points on the virtual detectors corresponding to one source position onto the smooth transition virtual flat detector, in accordance with an embodiment of the present invention. Along the horizontal axis is the physical detector pixel number, and along the vertical axis is the virtual detector coordinate. The closer the curve is to a line, the better.

FIG. 5b illustrates projected data points on the virtual detectors corresponding to one source position on the circular virtual detector. Along the horizontal axis is the physical detector pixel number, and along the vertical axis is the virtual detector coordinate. The closer the curve is to a line, the better.

FIG. 6 illustrates the CT reconstruction result based on the virtual flat detector with sharp transition.

FIG. 7 illustrates the error image (estimated-truth) of the CT reconstruction result based on the virtual flat detector with sharp transition.

FIG. 8 illustrates the CT reconstruction result based on the virtual flat detector with smooth transition.

FIG. 9 illustrates the error image (estimated-truth) of the CT reconstruction result based on the virtual flat detector with smooth transition.

FIG. 10 illustrates the CT reconstruction result based on the virtual circular detector with the truncated Hilbert kernel.

FIG. 11 illustrates the error image (estimated-truth) of the CT reconstruction result based on the virtual circular detector with the truncated Hilbert kernel.

FIG. 12 illustrates CT reconstruction result based on the virtual circular detector with 2048 interpolation points over the projected ROI.

FIG. 13 illustrates the error image (estimated-truth) of the CT reconstruction result based on the virtual circular detector with 2048 interpolation points over the projected ROI.

FIG. 14 illustrates the compressed gray scale image in the range [−0.2 0.2] with virtual flat detector with smooth transition.

FIG. 15 illustrates the compressed gray scale image in the range [0.8 1.2] with virtual flat detector with smooth transition.

FIG. 16 illustrates the sampled locations where profiles are taken for comparison: blue at y=146, red at y=256, yellow at y=367, purple at x=533, and green at x=682.

FIG. 17 illustrates the comparison of the reconstructed profiles at y=146.

FIG. 18 illustrates the comparison of the reconstructed profiles at y=256.

FIG. 19 illustrates the comparison of the reconstructed profiles at y=367.

FIG. 20 illustrates the comparison of the reconstructed profiles at x=533.

FIG. 21 illustrates the comparison of the reconstructed profiles at x=682.

FIG. 22 illustrates the data availability in angular coordinates, in accordance with an exemplary embodiment of the present invention.

FIG. 23 illustrates the Gaussian mixture density, in accordance the exemplary embodiment of the present invention.

FIG. 24 illustrates the weight function, in accordance with the exemplary embodiment of the present invention.

FIG. 25a illustrates the weight function at z=0, in accordance with the exemplary embodiment of the present invention.

FIG. 25b illustrates the weight function at z=0.3, in accordance with the exemplary embodiment of the present invention.

FIG. 25c illustrates the weight function at z=0.4, in accordance with the exemplary embodiment of the present invention.

FIG. 25d illustrates the weight function at z=0.5, in accordance with the exemplary embodiment of the present invention.

FIG. 26 illustrates the cylindrical phantom reconstruction results using a prior art solution.

FIG. 27 illustrates the cylindrical phantom construction results using the improved algorithm of the present, using the same data as that show in FIG. 26.

FIG. 28 illustrates the error map associated with the cylindrical phantom reconstruction results shown in FIG. 26.

FIG. 29 illustrates the error map associated with the cylindrical phantom reconstructions results shown in FIG. 27.

FIG. 30 illustrates the ellipsoids phantom reconstruction results at z=0, using a prior art solution.

FIG. 31 illustrates the ellipsoids phantom construction results at z=0, using the improved algorithm of the present, using the same data as that show in FIG. 38.

FIG. 32 illustrates the ellipsoids phantom reconstruction results at z=0.5, using a prior art solution.

FIG. 33 illustrates the ellipsoids phantom construction results at z=0,5, using the improved algorithm of the present, using the same data as that show in FIG. 32.

FIG. 34 illustrates the ellipsoids phantom reconstruction results at z=0.3, using a prior art solution.

FIG. 35 illustrates the ellipsoids phantom construction results at z=0.3, using the improved algorithm of the present, using the same data as that show in FIG. 34.

FIG. 36 illustrates the error map of the reconstruction results of FIG. 30.

FIG. 37 illustrates the error map of the reconstruction results of FIG. 31.

FIG. 38 illustrates the error map of the reconstruction results of FIG. 32.

FIG. 39 illustrates the error map of the reconstruction results of FIG. 33.

FIG. 40 illustrates the error map of the reconstruction results of FIG. 34.

FIG. 41 illustrates the error map of the reconstruction results of FIG. 35.

### DETAILED DESCRIPTION OF THE INVENTION

In various embodiments, the present invention provides a new image reconstruction method, which can be applied to the Stationary Gantry Type Computed Tomography (SGCT) systems. The method is referred to throughout this document as No View Differentiation (NVD) reconstruction algorithm. In various embodiments, a family of algorithms is described that can be cast into the NVD form. These algorithms use redundancy weighting, which can be used to optimize image quality.

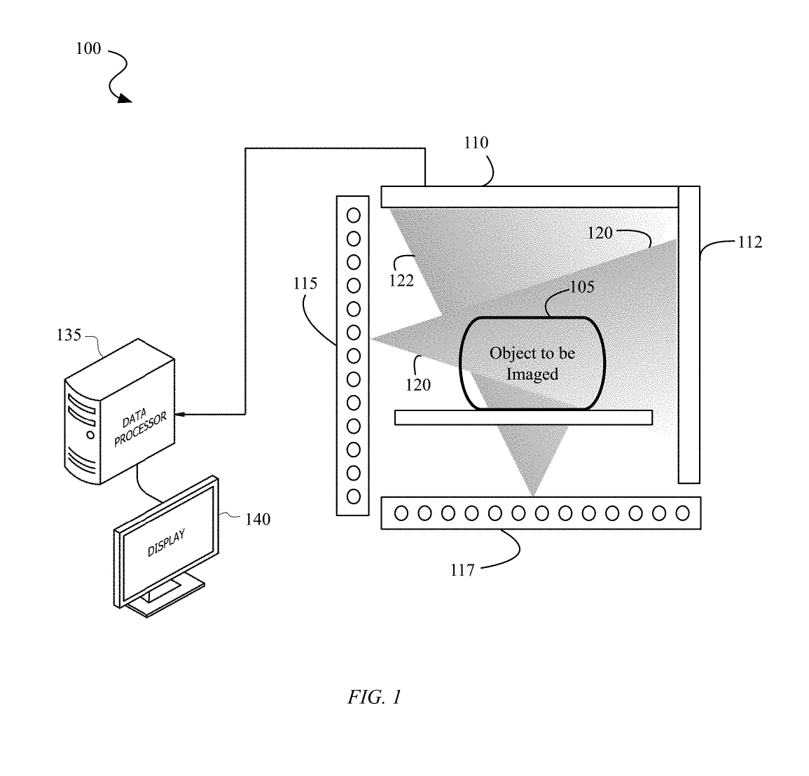

With reference to FIG. 1, an image reconstruction system 100 in accordance with the present invention may be implemented on a data processor 135 for performing the no-view differentiation reconstruction method of the present invention. The no-view differentiation reconstruction method receives tomographic cone beam data of an image of an object 105 collected by a scanner, wherein the scanner comprises a plurality of stationary sources 115, 117 to transmit x-rays 120, 122 in a non-sequential order and a plurality of stationary detectors 110, 112 to receive the transmitted x-rays 120, 122, which constitute the tomographic cone beam data (or, projections) of the object. The system may further include a display 140 for displaying the results of the image reconstruction performed by the data processor 135.

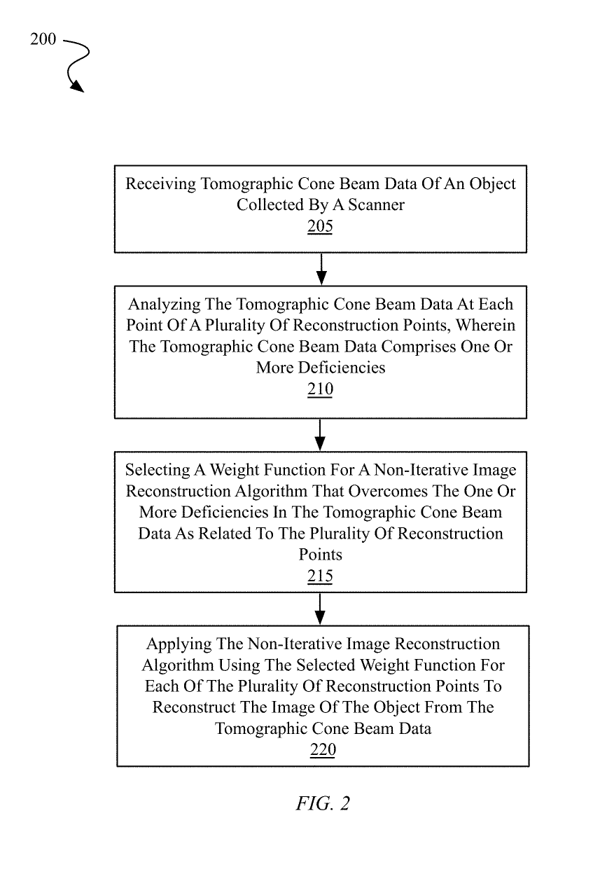

With reference to FIG. 2, the present invention provides an image reconstruction method 200 for stationary or fixed computed tomography. In a first step 205, the method includes receiving tomographic cone beam data of an object collected by a scanner. In a next step 210, the method includes analyzing the tomographic cone beam data at each point of a plurality of reconstruction points, wherein the tomographic cone beam data comprises one or more deficiencies. In a next step 215, the method continues by selecting a weight function for a non-iterative image reconstruction algorithm that overcomes the one or more deficiencies in the tomographic cone beam data as related to the plurality of reconstruction points. The method concludes by applying the non-iterative image reconstruction algorithm using the selected weight function for each of the plurality of reconstruction points to reconstruct the image of the object from the tomographic cone beam data.

We start in the setting of 2D tomography. Let ƒ (\vec{x}), \vec{x}=(x₁, x₂), denote a function, and \vec{ƒ}(α, p) denote its Radon transform.

Consider reconstruction of a given slice, e.g. x₃=0, from the SGCT data. Two key features of the SGCT system are (1) Each view is collected at a different x₃ value, and (2) The fan angle is fairly large. From (1) we conclude that differentiation between x-rays collected at different source positions should be avoided. From (2) we conclude that the approximation inherent in reconstruction, which uses ramp filtering of fan beam projections, may lead to noticeable artifacts.

Let \vec{y} denote the source position, and Θ=(cos θ, sin θ) denote the fan angle. Consider the following integral

$$\begin{matrix}{\int }_{0}^{2 π} \frac{{\partial }_{θ} \hat{f} ( \vec{y} , θ )}{sin θ} d θ = {\int }_{0}^{2 π} {\int }_{0}^{∞} \frac{1}{sin θ} {\partial }_{θ} f ( \vec{y} + t ( cos θ , sin θ ) ) dtd θ \\ = {\int }_{0}^{2 π} {\int }_{0}^{∞} \frac{1}{t sin θ} ( {f}_{1}^{′} ( \cdot ) ( - t sin θ ) + {f}_{2}^{′} ( \cdot ) t cos θ ) tdtd θ \\ = {\int }_{{ℝ}^{2}} \frac{{f}_{1}^{′} ( \vec{y} + \vec{x} ) ( - {x}_{2} ) + {f}_{2}^{′} ( \vec{y} + \vec{x} ) {x}_{1}}{{x}_{2}} {dx}_{1} {dx}_{2} \\ = {\int }_{{ℝ}^{2}} \frac{{f}_{2}^{′} ( \vec{x} ) ( {x}_{1} - {y}_{1} )}{{x}_{2} - {y}_{2}} {dx}_{1} {dx}_{2} .\end{matrix} \qquad ( 1 )$$

Rewrite the result of (1) in a more general form. Pick some direction Θ₀=(cos θ₀, sin θ₀). Then (1) implies:

$${\int }_{0}^{2 π} \frac{{\partial }_{θ} \hat{f} ( \vec{y} , θ )}{sin ( θ - {θ}_{0} )} d θ = {\int }_{{ℝ}^{2}} \frac{\frac{d}{dp} f ( t {Θ}_{0} + p {Θ}_{0}^{⊥} ) ( t - \vec{y} \cdot {Θ}_{0} )}{p - \vec{y} \cdot p {Θ}_{0}^{⊥}} dtdp . \qquad ( 2 )$$

Aside from the factor t−\vec{y}·Θ₀ in the numerator, the right side of (2) resembles the ramp filtered Radon transform of ƒ.

Suppose there are two points on the source trajectory such that \vec{y}₂=\vec{y}₁+DΘ₀, where D=|\vec{y}₂−\vec{y}₁|. Clearly,

p₀:=\vec{y}₁·Θ₀^{⊥}=y₂·Θ₀^{⊥}, (3)

and

\vec{y}₁=t₁Θ₀+p₀Θ₀^{⊥},\vec{y}₂=t₂Θ₀+p₀Θ₀^{⊥} (4)

for some t₁ and t₂. We apply (2) two times: with (\vec{y}₁, Θ₀) and (\vec{y}₂, −Θ₀). This gives:

$$\begin{matrix} {G}_{1} = {\int }_{{ℝ}^{2}} \frac{\frac{d}{dp} f ( t , p ) ( t - {t}_{1} )}{p - {p}_{0}} dtdp , & ( 5 ) \\ {G}_{2} = {\int }_{{ℝ}^{2}} \frac{\frac{d}{dp} f ( - t , - p ) ( t + {t}_{2} )}{p + {p}_{0}} dtdp = {\int }_{{ℝ}^{2}} \frac{\frac{d}{dp} f ( t , p ) ( t2 - t )}{p - {p}_{0}} dtdp . & \end{matrix}$$

Adding the two equations in (5) gives

$${\int }_{{ℝ}^{2}} \frac{\frac{d}{dp} f ( t , p )}{p - {p}_{0}} dtdp = \frac{{G}_{1} + {G}_{2}}{\vert {\vec{y}}_{2} - {\vec{y}}_{1} \vert} . \qquad ( 6 )$$

Equation (6) is an exact way of computing the ramp-filtered Radon transform of ƒ from the data at two sources. Notice from (2) that the derivative and the Hilbert transform are applied only within each view (i.e., not between views).

Using (6) we will now obtain the final inversion formula. The conventional parallel-beam inversion formula is given by

$$f ( \vec{x} ) = - \frac{1}{4 π} {\int }_{0}^{2 π} \{ \frac{d}{dq} g ( Θ , q ) {\vert}_{q = \vec{x} \cdot Θ} \} d θ , \qquad ( 7 )$$

where [symbol] denotes the Hilbert transform:

$$g ( \cdot , q ) = \frac{1}{π} {\int }_{ℝ} \frac{g ( \cdot , p )}{p - q} dp . \qquad ( 8 )$$

In view of (2), denote:

$$G ( \vec{y} , θ ) = {\int }_{0}^{2 π} \frac{{\partial }_{γ} \hat{f} ( \vec{y} , γ )}{sin ( γ - θ )} d γ . \qquad ( 9 )$$

Combining (2), (6), and (9), we obtain:

$$f ( \vec{x} ) = - \frac{1}{4 π} {\int }_{0}^{2 π} \frac{G ( {\vec{y}}_{1} , θ ) + G ( {\vec{y}}_{2} , θ + π )}{\vert {\vec{y}}_{2} - {\vec{y}}_{1} \vert} d θ , \qquad ( 10 )$$

where \vec{y}₁ and \vec{y}₂ are points on the source trajectory determined from the following conditions:

\vec{x}=\vec{y}₁+t₁Θ=\vec{y}₂−t₂Θ,t₁,t₂>0. (11)

In particular, the chord [\vec{y}₁, \vec{y}₂] is parallel to Θ and contains \vec{x}. Denote

D(\vec{x},θ)=|\vec{y}₂−\vec{y}₁=t₁+t₂. (12)

Clearly,

G(\vec{y}₁,θ)=G(\vec{y}₂,θ+π),D(\vec{x},θ)=D(\vec{x},θ+π). (13)

### Hence

$$\begin{matrix}f ( \vec{x} ) = - \frac{1}{4 π} {\int }_{0}^{2 π} \frac{G ( {\vec{y}}_{1} , θ ) + G ( {\vec{y}}_{2} , θ + π )}{D ( \vec{x} , θ )} d θ \\ = - \frac{1}{4 π} {\int }_{0}^{2 π} \frac{G ( {\vec{y}}_{1} , θ )}{D ( \vec{x} , θ )} d θ - \frac{1}{4 π} {\int }_{0}^{2 π} \frac{G ( {\vec{y}}_{2} , θ + π )}{D ( \vec{x} , θ )} d θ \\ = - \frac{1}{2 π} \frac{G ( {\vec{y}}_{1} , θ )}{D ( \vec{x} , θ )} d θ .\end{matrix} \qquad ( 14 )$$

Substituting (9) gives the first inversion formula:

$$f ( \vec{x} ) = - \frac{1}{2 π} {\int }_{0}^{2 π} \frac{1}{D ( \vec{x} , θ )} {\int }_{0}^{2 π} \frac{{\partial }_{γ} \hat{f} ( {\vec{y}}_{1} , γ )}{sin ( γ - θ )} d γ d θ . \qquad ( 15 )$$

Integration with respect to the polar angle θ is not convenient from the computational point of view. Instead, integration with respect to the parameter along the source trajectory is preferred. Suppose \vec{y}(s) is some parametrization of the source trajectory. By a geometric argument,

$$d θ = \frac{cos α \vert {\vec{y}}^{′} ( s ) \vert ds}{\vert \vec{x} - \vec{y} ( s ) \vert} , \qquad ( 16 )$$

where cos α>0 is the angle between \vec{y}′(s) and (\vec{x}−\vec{y}(s))^{⊥}. Thus,

$$cos α = sin ( α + π / 2 ) = \frac{\vert {\vec{y}}^{′} ( s ) \times ( \vec{x} - \vec{y} ( s ) ) \vert}{\vert {\vec{y}}^{′} ( s ) \vert \cdot \vert \vec{x} - \vec{y} ( s ) \vert} . \qquad ( 17 )$$

Substituting (17) into (15) we obtain

$$f ( \vec{x} ) = - \frac{1}{2 π} {\int }_{S} \frac{\vert {\vec{y}}^{′} ( s ) \times ( \vec{x} - \vec{y} ( s ) ) \vert}{D ( \vec{x} , θ ) {\vert \vec{x} - \vec{y} ( s ) \vert}^{2}} {\int }_{0}^{2 π} \frac{{\partial }_{γ} \hat{f} ( \vec{y} ( s ) , γ )}{sin ( γ - θ )} d γ ds , \\ ( cos θ , sin θ ) = \frac{\vec{x} - \vec{y} ( s )}{\vert \vec{x} - \vec{y} ( s ) \vert} , \qquad ( 18 )$$

where S is the parametric interval that describes the source trajectory. Equation (18) is the final inversion formula. It holds under the assumption that the source trajectory is convex.

For a flat panel detector, integration with respect to the parameter along the detector plane is more convenient than integration along the polar angle γ. To do so, define

u=R tan γ, (19)

where u is the coordinate along the detector (with the origin at the central ray position), and R is the distance from \vec{y} to the detector plane. Then, after changing variables, the final equation for the flat panel detector is

$$f ( \vec{x} ) = - \frac{1}{2 π} {\int }_{S} \frac{\vert {\vec{y}}^{′} ( s ) \times ( \vec{x} - \vec{y} ( s ) ) \vert}{D ( \vec{x} , θ ) {\vert \vec{x} - \vec{y} ( s ) \vert}^{2}} \frac{\sqrt{{R}^{2} + {u}_{0}^{2} ( \vec{x} , s )}}{R} \cdot ( {\int }_{- ∞}^{∞} \frac{{\partial }_{u} \hat{f} ( \vec{y} ( s ) , γ ( u ) ) \sqrt{{R}^{2} + {u}^{2}}}{u - {u}_{0} ( \vec{x} , s )} du ) ds , \qquad ( 20 )$$

Here u₀(\vec{x}, s) is the u-coordinate of the point, where the ray with vertex at \vec{y}(s) passing through z hits the detector plane.

As expected, reconstruction formulas (18), (20) involve no view differentiation. For this reason, the resulting algorithm is called No View Differentiation (NVD) reconstruction.

In general, the derivation above is one of possible ways to derive one possible 2D NVD algorithm. Certainly, other derivation approaches and other 2D NVD algorithms exist. This multitude of reconstruction algorithms is due to the fact that the 2D tomographic data are redundant (there exist so-called range conditions), and different algorithms treat the redundant data in different ways.

Here we describe another family of NVD algorithms, which may have an advantage over the one previously described. In terms of our notation (cf. (18)), the formula (26) of F. Noo, M. Defrise, R. Clackdoyle, et al., “Image reconstruction from fan-beam projections on less than a short scan, Physics in Medicine and Biology 47, 2525-2546 (2002) reads:

$$f ( \vec{x} ) = - \frac{1}{2 π} {\int }_{S} \frac{w ( \vec{x} , θ ( \vec{x} , s ) )}{\vert \vec{x} - \vec{y} ( s ) \vert} {\int }_{0}^{2 π} \frac{{\partial }_{s} \hat{f} ( \vec{y} ( s ) , γ )}{sin ( γ - θ ( \vec{x} , s ) )} d γ ds , \qquad ( 21 )$$

where θ=θ(\vec{x}, s) solves the equation

$$( cos θ , sin θ ) = \frac{\vec{x} - \vec{y} ( s )}{\vert \vec{x} - \vec{y} ( s ) \vert} . \qquad ( 22 )$$

Also, w(\vec{x}, θ) is the weight that controls the utilization of redundant information. It can be almost any function that satisfies the normalization condition:

w(\vec{x},θ)+w(\vec{x},θ+π)=1 (23)

for all reconstruction points \vec{x} and all angles θ∈[0, 2π). Integrating by parts in (21) with respect to s, we can remove the view-derivative, thereby obtaining a family of NVD algorithms.

Let us consider the role of w in more detail. Mathematically, w(\vec{x}, θ) is the weight with which the filtered data at the source \vec{y}(s) contributes to the image reconstructed at \vec{x}. Here \vec{y}(s) is such that it satisfies the last equation in (21). Pick any \vec{x} and θ∈[0, 2π), and find the pair of sources \vec{y}(s₁), \vec{y}(s₂) such that \vec{x} is on the chord [\vec{y}(s₁), \vec{y}(s₂)], and

$$( cos θ , sin θ ) = \frac{\vec{y} ( {s}_{2} ) - \vec{y} ( {s}_{1} )}{\vert \vec{y} ( {s}_{2} ) - \vec{y} ( {s}_{1} ) \vert} . \qquad ( 24 )$$

The data at \vec{y}(s₁) and \vec{y}(s₂) contribute the same information to the image at \vec{x}, in the context of helical CT, the points \vec{y}(s₁) and \vec{y}(s₂) are called π-partners. Hence, the freedom in the choice of w gives us one possible way for accomodating the peculiarities of the scanner and improving image quality. For example, it may turn out that view sampling in a neighborhood of \vec{y}(s₁) is finer than view sampling in a neighborhood of \vec{y}(s₂). Therefore, we can increase w(\vec{x}, θ) (the weight for the contribution of \vec{y}(s₁)), and decrease w(\vec{x}, θ+π) (the weight for the contribution of \vec{y}(s₂)). Other factors that may affect the weight can include, for example:
1. Noise in the data. E.g., data at one source can be noiser than at the other source and, therefore, the former should be down-weighted.
2. Local spatial resolution. The point \vec{x} can be seen with two fairly different resolutions from \vec{y}(s₁) and \vec{y}(s₂). This resolution depends on the magnification factor, the tilt of the detector element relative to the line through the source and \vec{x}, and some other parameters. Thus, we can downweight the source, which provides lower-resolution contribution.
3. Anticipating the use of the algorithm in a 3D setting, we can reduce cone beam artifacts by downweighting the source with the higher cone angle relative to \vec{x}.
4. In 3D, the source trajectory is not periodic. It only appears periodic when projected onto the appropriate plane. The weight can be selected to go to zero near the point of discontinuity to reduce possible artifacts caused by that discontinuity.

In the SGCT case of the present invention, the reconstruction method is applied to cone beam data, in which neighboring sources collect views at fairly different locations along the axial (x₃) direction. Hence, differentiation between views may lead to artifacts that would not be present if all the views were along a smooth curve. In a similar fashion, even though integration by parts leads to a mathematically equivalent expression, the result may be a numerically non-equivalent formula due to various cone beam approximations.

Denoting w(\vec{x}, s):=w(\vec{x}, θ(\vec{x}, s)) and integrating by parts in (21) we obtain

$$f ( \vec{x} ) = \frac{1}{2 π} {\int }_{S} ( \frac{\partial }{\partial s} \frac{w ( \vec{x} , s )}{\vert \vec{x} - \vec{y} ( s ) \vert} ) {\int }_{0}^{2 π} \frac{\hat{f} ( \vec{y} ( s ) , γ )}{sin ( γ - θ ( \vec{x} , s ) )} d γ ds + \frac{1}{2 π} {\int }_{S} \frac{w ( \vec{x} , s ) \vert {\vec{y}}^{′} ( s ) \times ( \vec{x} - \vec{y} ( s ) ) \vert}{{\vert \vec{x} - \vec{y} ( s ) \vert}^{3}} {\int }_{0}^{2 π} \frac{{\partial }_{γ} \hat{f} ( \vec{y} ( s ) , γ )}{sin ( γ - θ ( \vec{x} , s ) )} d γ ds . \qquad ( 25 )$$

Similarly to (20), the analogue of (25) for the flat detector is

$$f ( \vec{x} ) = \frac{1}{2 π} {\int }_{S} ( \frac{w ( \vec{x} , s ) ( {\vec{y}}^{′} ( s ) \cdot ( \vec{x} - \vec{y} ( s ) ) )}{{\vert \vec{x} - \vec{y} ( s ) \vert}^{3}} + \frac{{w ( \vec{x} , s )}^{′}}{\vert \vec{x} - \vec{y} ( s ) \vert} ) \cdot \sqrt{{R}^{2} + {u}_{0}^{2} ( \vec{x} , s )} {\int }_{- ∞}^{∞} \frac{\hat{f} ( \vec{y} ( s ) , γ ( u ) ) / \sqrt{{R}^{2} + {u}^{2}}}{u - {u}_{0} ( \vec{x} , s )} duds + \frac{1}{2 π} {\int }_{S} \frac{w ( \vec{x} , s ) \vert {\vec{y}}^{′} ( s ) \times ( \vec{x} - \vec{y} ( s ) ) \vert}{{\vert \vec{x} - \vec{y} ( s ) \vert}^{3}} \cdot \frac{\sqrt{{R}^{2} + {u}_{0}^{2} ( \vec{x} , s )}}{R} {\int }_{- ∞}^{∞} \frac{{\partial }_{u} \hat{f} ( \vec{y} ( s ) , γ ( u ) ) \sqrt{{R}^{2} + {u}^{2}}}{u - {u}_{0} ( \vec{x} , s )} duds . \qquad ( 26 )$$

For image reconstruction for the SGCT, we select w that reduces streaks due to irregular view sampling. In irregular view sampling, the angles between neighboring line segments formed between a particular reconstruction point and a source are not equiangular. The situation where some of the angles are large and some are small, results in irregular view sampling, which results in undesirable artifacts in the reconstructed images.

To address the problem with irregular view sampling, we compute an availability map for every image plane. Let p denote the 2D index of an image pixel in the plane, and j denote the source index. The availability map mₛ(p, j) contains binary information for each pixel-source pair (p, j). The map shows whether the image pixel p is visible (i.e., projects on the detector) from the source j:

$${m}_{s} ( p , j ) = \{ \begin{matrix}1 , & if the pth image pixel is visible from the jth source \\ 0 , & otherwise\end{matrix} . \qquad ( 27 )$$

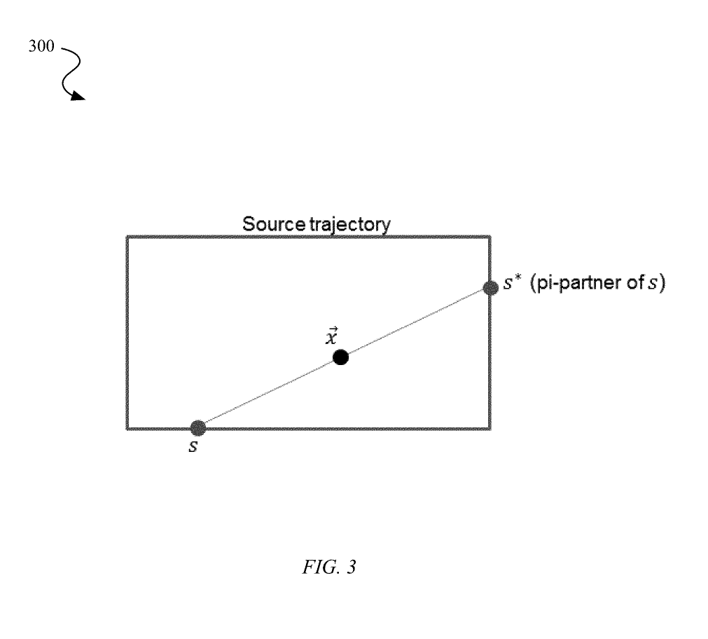

Using the availability map described in (27), a periodic Gaussian mixture density function in the angular domain ρ(p, θ) is first computed for each image pixel p. The Gaussian mixture approach uses the discrete availability map and obtains a smooth function on the unit circle parametrized by θ:

$$ρ ( p , θ ) = {\sum }_{j} {m}_{s} ( p , j ) exp ( - \frac{min ( \vert θ - {θ}_{( p , j )} \vert , 2 π - \vert θ - {θ}_{( p , j )} \vert )}{2 {σ}_{s}^{2}} ) , \qquad ( 28 )$$

where θ_{(p,j)}=θ(\vec{x}ₚ, sⱼ). To make sure that the weight w satisfies the normalization condition (23), we use the formula:

$${w}_{( p , j )} = \frac{{ρ ( p , {θ}_{( p , j )} )}^{{t}_{w}}}{{ρ ( p , {θ}_{( p , j )} )}^{{t}_{w}} + {ρ ( p , {θ}_{( p , j )} + π )}^{{t}_{w}}} , {t}_{w} \geq 0 \qquad ( 29 )$$

where t_{w} adjusts the weight bias between pi-partners. The pi-partners 300 relative to the source trajectory are illustrated with reference to FIG. 3. If t_{w}=0, then w=½ for both pi-partners in each pair. If t_{w}=∞, then the partner with the higher density between pi-partners will have weight w=1, and the other partner—weight w=0. Lower σₛ and higher t_{w} will decrease streak artifacts, but will also increase the numerical error since w becomes less smooth. Computing w for each image plane is time consuming, and saving the pre-computed values takes large amount of memory. Fortunately, with large enough σₛ, the Gaussian mixture density for each image plane is almost constant along x₃. Thus, we used the pre-computed w, which was averaged over several slices.

Even though in some cases one cannot talk about the source trajectory in the classical sense (e.g., in the case when stationary sources are fired non-sequentially), the sources themselves may be arranged along a curve. Furthermore, when sources are projected onto a plane, they also may appear to lie on a curve. Therefore, in any of these more general senses (i.e., ignoring the firing order, for example), we can still talk about source trajectory.

In irregular view-sampling, given a continuous section of the source trajectory and a reconstruction point x, not for all sources in that section the point x is visible on the detector. There can be a subset of sources distributed in an irregular manner over that section for which the point x is not visible on the detector (“invalid” sources). For some sections of the trajectory, the number of these invalid sources can be small, and for other sections the number of these invalid sources can be large. Therefore, we can say that some portions of the source trajectory (as projected onto a plane) are well sampled, and some portions of the source trajectory are poorly sampled. Accordingly, the weight function w is designed to overcome the artifacts resulting from this irregular view-sampling.

Even though a CT detector is usually a 2D surface, when projected onto a proper plane the detector will appear as a curve. In this sense we may say that the detector is located on a curve.

The detector in the SGCT scanner has a shape, which does not allow for filtering in native detector coordinates. The requirement of shift-invariant convolution filtering imposes a restriction on the shape of the detector. Two most common shapes that satisfy the restriction are circular (centered on the source) and flat. Also, the data need to lie on a uniform grid in order to implement the convolutions using fast Fourier transform (FFT). Hence, to compute the Hilbert transforms in (18) and (20) using FFT, one must project the data onto a virtual detector, and then interpolate the projected data to a uniform grid. The following steps are performed to apply the Hilbert transform to the data projected onto the virtual detector: For each source location,
(1) Define the virtual detector geometry (flat or circular).
(2) Find all effective detector pixels that have the information about the ROI.
(3) (If the virtual detector is flat,) apply the central difference to compute ∂ᵤ\hat{ƒ}.
(4) Project the effective detector pixels onto the virtual detector. The range of projected pixels (which is the same as the projected ROI) is called “projected ROI range”, or “projected ROI” for short.
(5) Interpolate data to build a uniform grid and perform zero padding.
(6) Perform the Hilbert transform if the virtual detector is flat, or apply the ramp filter if the virtual detector is circular.
(7) Back-projection, which includes interpolating the filtered values at the required intermediate points.

Three different virtual detector geometries have been tested:
(a) Extend one of the original detector faces that is on the opposite side of the source (sharp transition).
(b) Define a new plane that is perpendicular to the source-to-origin line (smooth transition).
(c) Define a circle centered at the current source position.
   In cases (a) and (b), the total number of points on the interpolated uniform grid within the projected ROI range is chosen to be equal to the total number of effective detector pixels. For (c, the interpolation from nonuniform grid to uniform grid requires a little more care, as described below.

Accurate ramp filtering for the circular detector using FFT requires zero-padding of the data so that the total number of points becomes the smallest multiple of 2 greater than 2N_{eff}, where N_{eff} is the number of effective detector pixels. Let the projected ROI be confined within [−Γ₀, Γ₀], and the corresponding zero-padded array be confined within [−Γ, Γ]. For simplicity, we will first discuss how to perform Hilbert filtering. Applying the ramp kernel is completely analogous.

To avoid aliasing, one approach to computing the Hilbert kernel for the circular detector in the discrete frequency domain is given by:

$$H ( j ) = - 2 i ( \frac{Γ}{sin Γ} Si ( j π ) - {\int }_{0}^{Γ} Si ( \frac{j π γ}{Γ} ) {u}^{′} ( γ ) d γ ) , \qquad ( 30 )$$

where Si(·) is the sine integral function, and u′ is defined as

$${u}^{′} ( t ) = \{ \begin{matrix}\frac{t}{3 - {t}^{2}} , & if t < 0.01 \\ \frac{sin t - t cos t}{{sin}^{2} t} , & otherwise\end{matrix} . \qquad ( 31 )$$

Notice that in (20) the range of angles over which the convolution is computed (after zero-padding) should be strictly inside [−π, π]. Otherwise the Hilbert kernel on the circle, 1/sin(γ), will have an additional singularity at the point γ=π. On the other hand, the condition that the number of uniform grid points and the number of the original data points over the projected ROI be equal may lead to the uniform grid becoming overly large. Indeed, suppose the number of the original data points is N_{eff}=600 in the range [−π/3, π/3]. Then the number of the uniform grid nodes over the same range should also be 600. So the uniform grid needs to be enlarged to 1024 (the closest higher power of 2), and then doubled again to 2048 due to zero padding. This means that the span of the uniform grid can be more than three times (2048/600≈3.4) larger than the span of the projected ROI, thereby easily violating the requirement to stay inside [−π, π]. Hence we are required to use a more dense uniform grid points that is a multiple of 2 than is optimal, thereby reducing image quality.

Another and better way to address this angle range issue is to separate the kernel length from the zero-padded domain length. Let Γ_{ƒ}=2Γ₀ be the half length of the finite support Hilbert kernel (this Hilbert kernel will be called “truncated Hilbert kernel” hereinafter), then the original equation (30) is modified as:

$$H ( j ) = - 2 i ( \frac{{Γ}_{f}}{sin {Γ}_{f}} Si ( \frac{j π {Γ}_{f}}{Γ} ) - {\int }_{0}^{{Γ}_{f}} Si ( \frac{j π γ}{Γ} ) {u}^{′} ( γ ) d γ ) . \qquad ( 32 )$$

Using (32) we can set the number of points on the uniform grid within the projected ROI to N_{eff} without violating the maximum range restriction. The advantage of (32) over (30) is that we truncate the Hilbert kernel to the minimal length that is sufficient to avoid aliasing (Γ_{ƒ}=2Γ₀) instead of using the standard length [−Γ, Γ].

The ramp kernel is obtained similarly to H(j) by the formula

$$R ( j ) = \frac{2 j π}{Γ} ( \frac{{Γ}_{f}}{sin {Γ}_{f}} Si ( \frac{j π {Γ}_{f}}{Γ} ) - {\int }_{0}^{{Γ}_{f}} Si ( \frac{j π γ}{Γ} ) {u}^{′} ( γ ) d γ ) . \qquad ( 33 )$$

Next we discuss how to perform integration with respect to s. Two novel points, that do not usually arise in conventional CT reconstruction, need to be addressed: (1) The source trajectory in the SGCT scanner has discontinuous tangent vector \vec{y}′(s), and (2) Due to the non-sequential source firing pattern, the sampling of the source trajectory is non-uniform. As an example, we will consider the inversion formula (20). The formula (18) can be considered in an analogous fashion.

Fix a reconstruction point \vec{x}. Let sⱼₖ, k=0, 1, . . . , be the subset of sources for which the point \vec{x} is “visible”. Thus, the corresponding views are used for backprojection to \vec{x}. Denote:

$$F ( s ) = - \frac{1}{2 π} \frac{1}{D ( \vec{x} , θ )} \frac{\sqrt{{R}^{2} + {u}_{0}^{2} ( \vec{x} , s )}}{R} \cdot ( {\int }_{- ∞}^{∞} \frac{{\partial }_{u} \hat{f} ( \vec{y} ( s ) , γ ( u ) ) \sqrt{{R}^{2} + {u}^{2}}}{u - {u}_{0} ( \vec{x} , s )} du ) . \qquad ( 34 )$$

Then, (20) can be written as follows

$$\begin{matrix}f ( \vec{x} ) = {\int }_{S} F ( s ) \frac{\vert {\vec{y}}^{′} ( s ) \times ( \vec{x} - \vec{y} ( s ) ) \vert}{{\vert \vec{x} - \vec{y} ( s ) \vert}^{2}} ds \\ \approx {\sum }_{k} F ( {s}_{{j}_{k}} ) {\int }_{{s}_{{j}_{k - 1}}}^{{s}_{{j}_{k + 1}}} {φ}_{k} ( s ) \frac{\vert {\vec{y}}^{′} ( s ) \times ( \vec{x} - \vec{y} ( s ) ) \vert}{{\vert \vec{x} - \vec{y} ( s ) \vert}^{2}} ds .\end{matrix} \qquad ( 35 )$$

Here ϕₖ (s) is a piecewise-linear interpolating kernel, which vanishes outside the interval [sⱼ_{_{k−1}}, sⱼ_{ₖ₊₁}], and has the properties:

ϕ(sⱼ_{_{k−1}})=ϕ(sⱼ_{ₖ₊₁})=0,ϕ(sⱼ_{ₖ})=1. (36)

SGCT's source trajectory is piecewise-linear, with changes in direction happening only at some sⱼ (but not between two consequtive sⱼ). Consider the last integral in (35). Since source sampling is expected to be fairly sparse, there is no guarantee that sⱼ_{_{k−1}}, sⱼ_{ₖ}, sⱼ_{ₖ₊₁} are three consequtive source positions, i.e. there is no guarantee that jₖ₋₁+1=jₖ and jₖ₊₁=jₖ₊₁. Therefore, we break up the overall integral into the integrals over smaller pieces between consequtive source positions:

$${\int }_{{s}_{{j}_{k - 1}}}^{{s}_{{j}_{k + 1}}} {φ}_{k} ( s ) \frac{\vert {\vec{y}}^{′} ( s ) \times ( \vec{x} - \vec{y} ( s ) ) \vert}{{\vert \vec{x} - \vec{y} ( s ) \vert}^{2}} ds = {\sum }_{j = {j}_{k - 1}}^{{j}_{k + 1} - 1} {\int }_{{s}_{j}}^{{s}_{j + 1}} {φ}_{k} ( s ) \frac{\vert {\vec{y}}^{′} ( s ) \times ( \vec{x} - \vec{y} ( s ) ) \vert}{{\vert \vec{x} - \vec{y} ( s ) \vert}^{2}} ds . \qquad ( 37 )$$

The sum on the right in (37) is over all pieces of the source trajectory located between the sources sⱼ_{_{k−1}} and sⱼ_{ₖ}. Within each such piece the source trajectory is linear, so \vec{y}′(s) is constant. Also, we may assume that the vector \vec{x}−\vec{y}(s) also stays constant there. Thus, we have

$${\int }_{{s}_{{j}_{k - 1}}}^{{s}_{{j}_{k + 1}}} {φ}_{k} ( s ) \frac{\vert {\vec{y}}^{′} ( s ) \times ( \vec{x} - \vec{y} ( s ) ) \vert}{{\vert \vec{x} - \vec{y} ( s ) \vert}^{2}} ds \approx {\sum }_{j = {j}_{k - 1}}^{{j}_{k + 1} - 1} \frac{\vert ( \vec{y} ( {s}_{j + 1} ) - \vec{y} ( {s}_{j} ) ) \times ( \vec{x} - \vec{y} ( {s}_{j}^{*} ) ) \vert}{{\vert \vec{x} - \vec{y} ( {s}_{j}^{*} ) \vert}^{2}} \frac{1}{{s}_{j + 1} - {s}_{j}} {\int }_{{s}_{j}}^{{s}_{j + 1}} {φ}_{k} ( s ) ds . \qquad ( 38 )$$

Here sⱼ* is the mid-point of the interval [sⱼ, sⱼ₊₁]. Since ϕ is a piecewise linear function, the integral on the right can be easily evaluated by applying the formula for the area of the trapezoid:

$${\int }_{{s}_{{j}_{k - 1}}}^{{s}_{{j}_{k + 1}}} {φ}_{k} ( s ) \frac{\vert {\vec{y}}^{′} ( s ) \times ( \vec{x} - \vec{y} ( s ) ) \vert}{{\vert \vec{x} - \vec{y} ( s ) \vert}^{2}} ds \approx {\sum }_{j = {j}_{k - 1}}^{{j}_{k + 1} - 1} \frac{\vert ( \vec{y} ( {s}_{j + 1} ) - \vec{y} ( {s}_{j} ) ) \times ( \vec{x} - \vec{y} ( {s}_{j}^{*} ) ) \vert}{{\vert \vec{x} - \vec{y} ( {s}_{j}^{*} ) \vert}^{2}} {φ}_{k} ( {s}_{j}^{*} ) . \qquad ( 39 )$$

Combining (39) with (34) gives an appropriate way for dealing with the discontinuity of \vec{y}′ when computing the integral with respect to s in (20). The weighted NVD (26) can be computed in the same manner. Define

$$\begin{matrix}{F}_{1} ( s ) = \frac{1}{2 π} \sqrt{{R}^{2} + {u}_{0}^{2} ( \vec{x} , s )} {\int }_{- ∞}^{∞} \frac{\hat{f} ( \vec{y} ( s ) , γ ( u ) ) / \sqrt{{R}^{2} + {u}^{2}}}{u - {u}_{0} ( \vec{x} , s )} du & ( 40 ) \\ {F}_{2} ( s ) = \frac{1}{2 π} \frac{\sqrt{{R}^{2} + {u}_{0}^{2} ( \vec{x} , s )}}{R} {\int }_{- ∞}^{∞} \frac{{\partial }_{u} \hat{f} ( \vec{y} ( s ) , γ ( u ) ) \sqrt{{R}^{2} + {u}^{2}}}{u - {u}_{0} ( \vec{x} , s )} du & ( 41 )\end{matrix}$$

Then, (26) can be written as follows

$$f ( \vec{x} ) = {\int }_{S} {F}_{1} ( s ) ( \frac{w ( \vec{x} , s ) ( {\vec{y}}^{′} ( s ) \cdot ( \vec{x} - \vec{y} ( s ) ) )}{{\vert \vec{x} - \vec{y} ( s ) \vert}^{3}} + \frac{{w ( \vec{x} , s )}^{′}}{\vert \vec{x} - \vec{y} ( s ) \vert} ) ds + {\int }_{S} {F}_{2} ( s ) \frac{w ( \vec{x} , s ) \vert {\vec{y}}^{′} ( s ) \times ( \vec{x} - \vec{y} ( s ) ) \vert}{{\vert \vec{x} - \vec{y} ( s ) \vert}^{3}} ds \approx {\sum }_{k} {F}_{1} ( {s}_{{j}_{k}} ) {\sum }_{j = {j}_{k - 1}}^{{j}_{k + 1} - 1} ( \frac{w ( \vec{x} , {s}_{j}^{*} ) ( ( \vec{y} ( {s}_{j + 1} ) - \vec{y} ( {s}_{j} ) ) \cdot ( \vec{x} - \vec{y} ( {s}_{j}^{*} ) ) )}{{\vert \vec{x} - \vec{y} ( {s}_{j}^{*} ) \vert}^{3}} + \frac{w ( \vec{x} , {s}_{j + 1} ) - w ( \vec{x} , {s}_{j} )}{\vert \vec{x} - \vec{y} ( {s}_{j}^{*} ) \vert} ) {φ}_{k} ( {s}_{j}^{*} ) + {F}_{2} ( {s}_{{j}_{k}} ) {\sum }_{j = {j}_{k - 1}}^{{j}_{k + 1} - 1} \frac{w ( \vec{x} , {s}_{j}^{*} ) \vert ( \vec{y} ( {s}_{j + 1} ) - \vec{y} ( {s}_{j} ) ) \times ( \vec{x} - \vec{y} ( {s}_{j}^{*} ) ) \vert}{{\vert \vec{x} - \vec{y} ( {s}_{j}^{*} ) \vert}^{3}} {φ}_{k} ( {s}_{j}^{*} ) . \qquad ( 42 )$$

The second issue to be addressed is the direction of filtering. Again, for simplicity, consider a flat virtual detector. The curved detector can be considered similarly. We propose to filter along the u coordinate in the uz coordinate system. More precisely, each row of the physical detector (which belongs to the appropriate plane z=const) is represented by a line of data points in the uz plane. Here z is the coordinate on the detector surface, which is along the direction perpendicular to detector rows. The derivative+Hilbert filtering in (20) will be performed along each such line separately. Consider now the backprojection step. Pick a reconstruction point (\vec{x}, x₃) and a source position sⱼ. Of course, the source sⱼ needs to be valid/active for the given point. To find the backprojection value, we interpolate in the uz plane. The value u(\vec{x}, sⱼ) is found by projecting \vec{x} onto the virtual detector. Note that the value of u is independent of the x₃-coordinate of the reconstruction point. The value of z((\vec{x}, x₃),sⱼ) is found by projecting (\vec{x}, x₃) onto the actual (or, physical) detector.

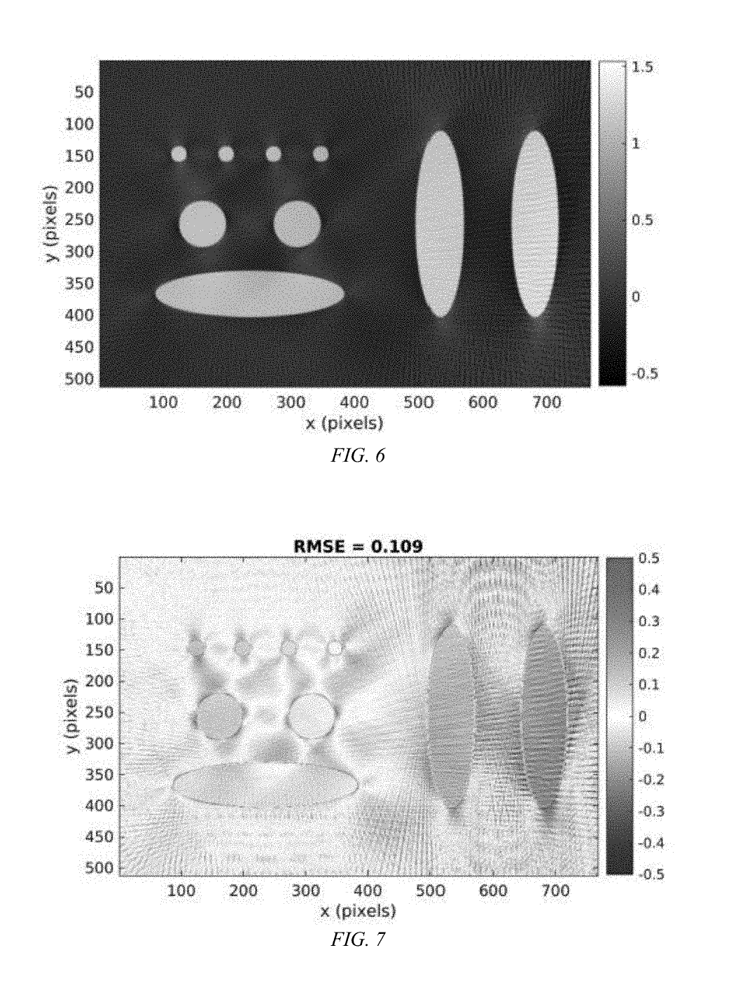

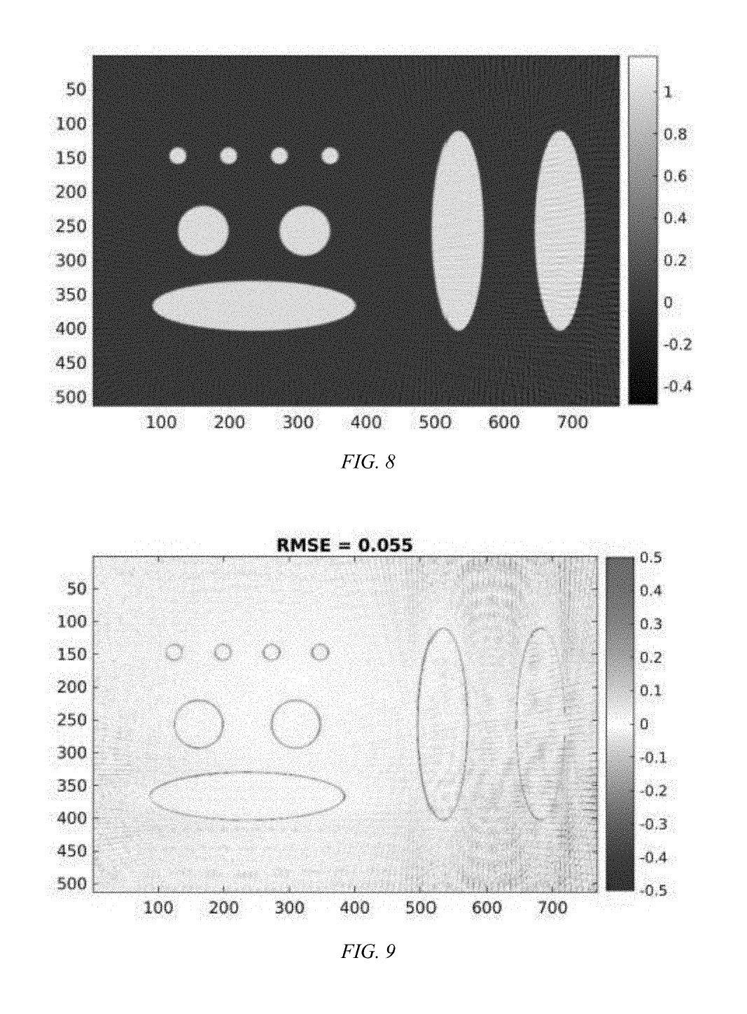

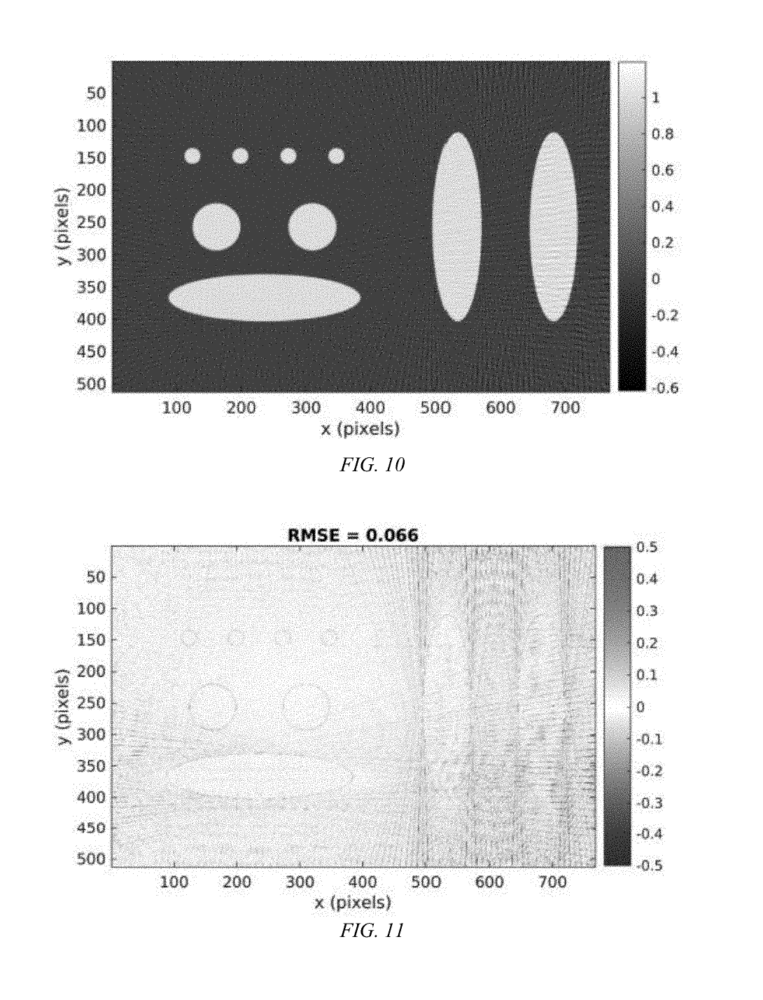

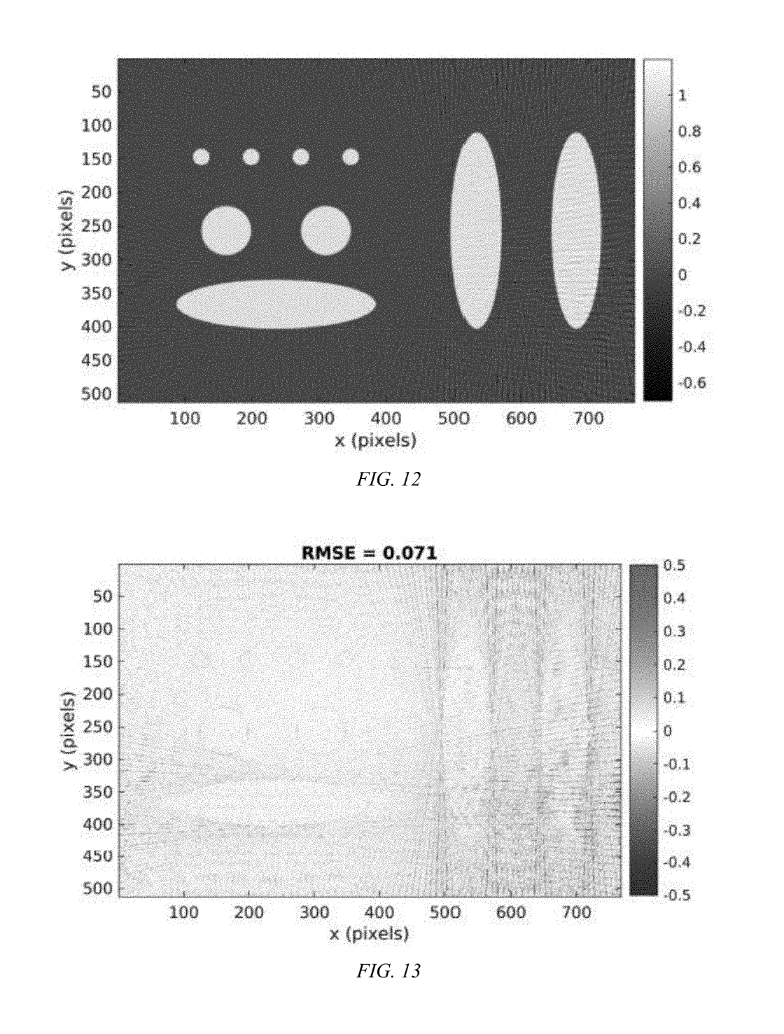

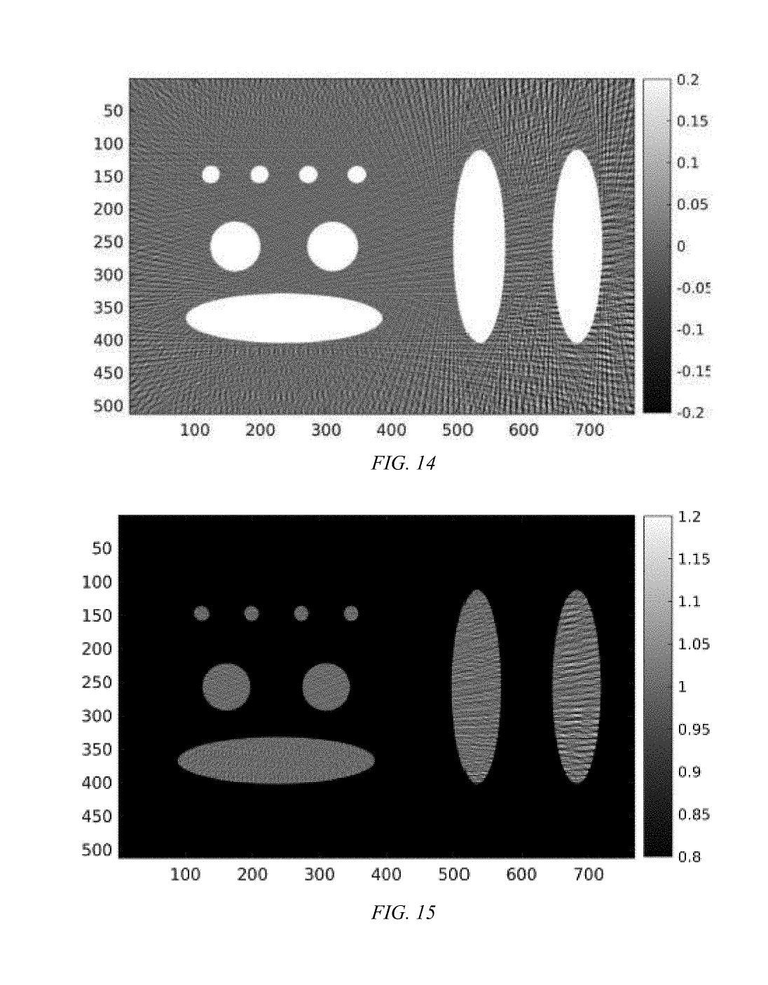

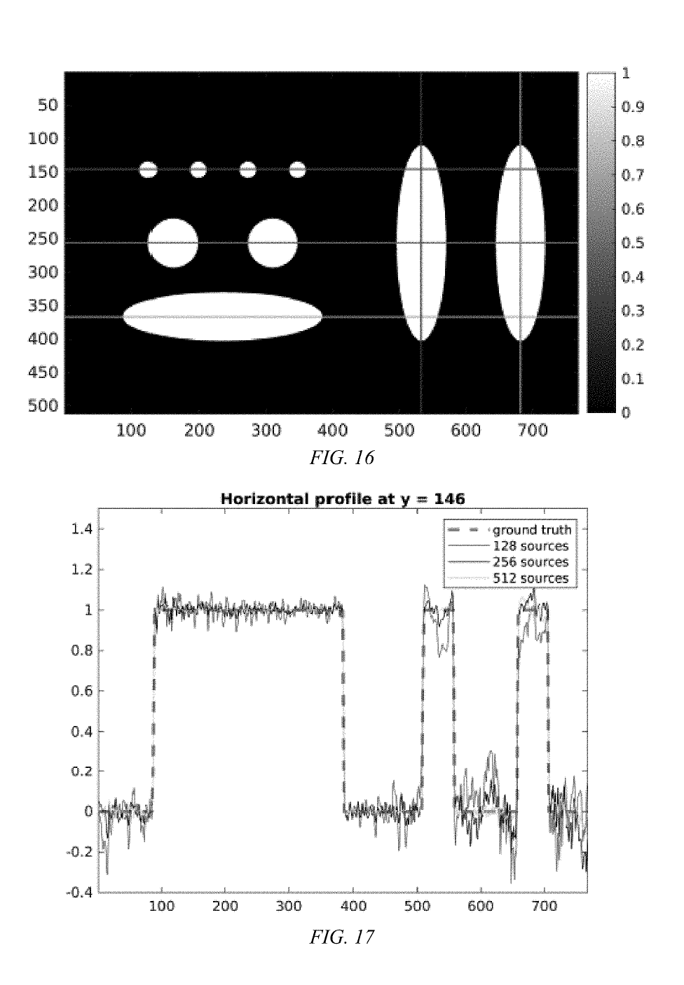

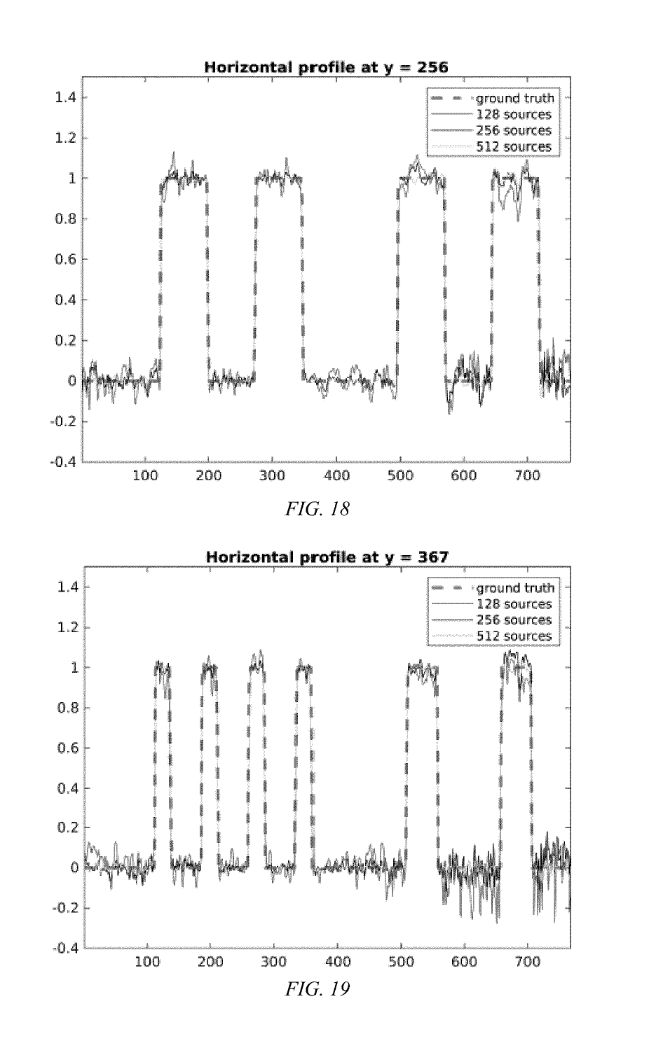

In an exemplary reconstruction with the 2D algorithm, the system is assumed to be monoenergetic, noiseless, and with the ideal focal spot. The phantom is assumed motionless, consisting of single material which has the unit attenuation coefficient. FIG. 4 shows the image of the phantom used for the simulation. FIGS. 6 and 8 show the result of the CT reconstruction based on (a) and (b), respectively, using all 256 sources. FIG. 10 shows the result of the CT reconstruction based on (c) with the truncated ramp kernel (equation (33)). Here we use the approach based on Γ_{ƒ}, and the stepsize of the uniform grid is chosen in an optimal way. FIG. 12 shows the result of the CT reconstruction based on (c) with fixed 2048 interpolation points over the projected ROI. In this approach, Γ_{ƒ} and Γ are the same as 2048 is a multiple of 2.

FIGS. 7, 9, 11, and 13 show the error image for FIGS. 6, 8, 10, and 12, respectively, which are obtained by subtracting the ground truth image from the corresponding reconstruction.

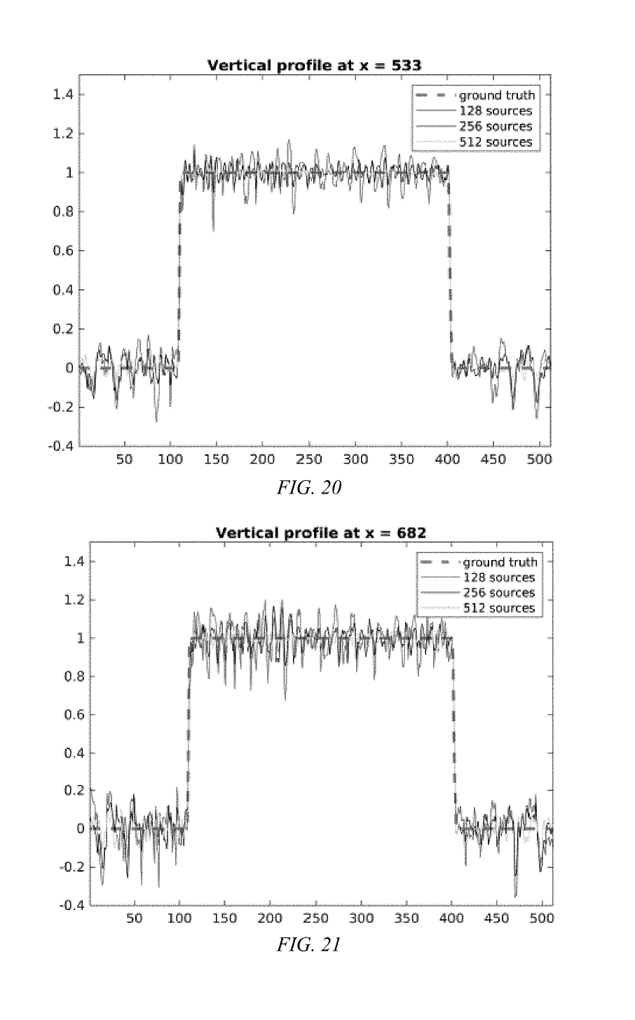

To better illustrate the artifacts in each image, the lower and upper compressed gray scale images in the ranges [−0.2 0.2] and [0.8 1.2] are also provided for the flat virtual detector with smooth transition, see FIGS. 20, 21.

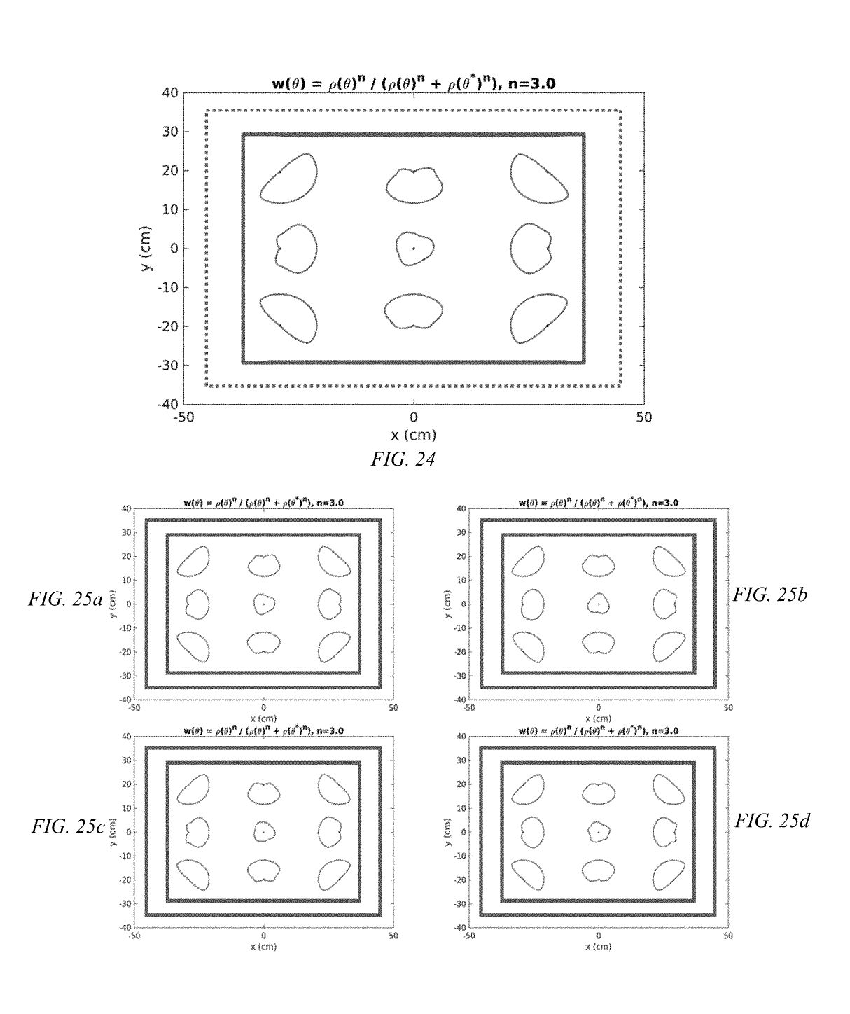

Finally, horizontal and vertical profiles along 5 different lines are plotted in FIGS. 25-29. The lines where the profiles are taken are shown in the FIG. 24.

In the following discussion, only the original 2D NVD results with noiseless data are shown and discussed. Results with noisy data reconstructed using the weighted NVD, NVD3D, and the advanced NVD3D are available.

Our first observation is that spatial resolution is both location- and direction-dependent. In the future, this information can be used to guide and optimize post-processing.

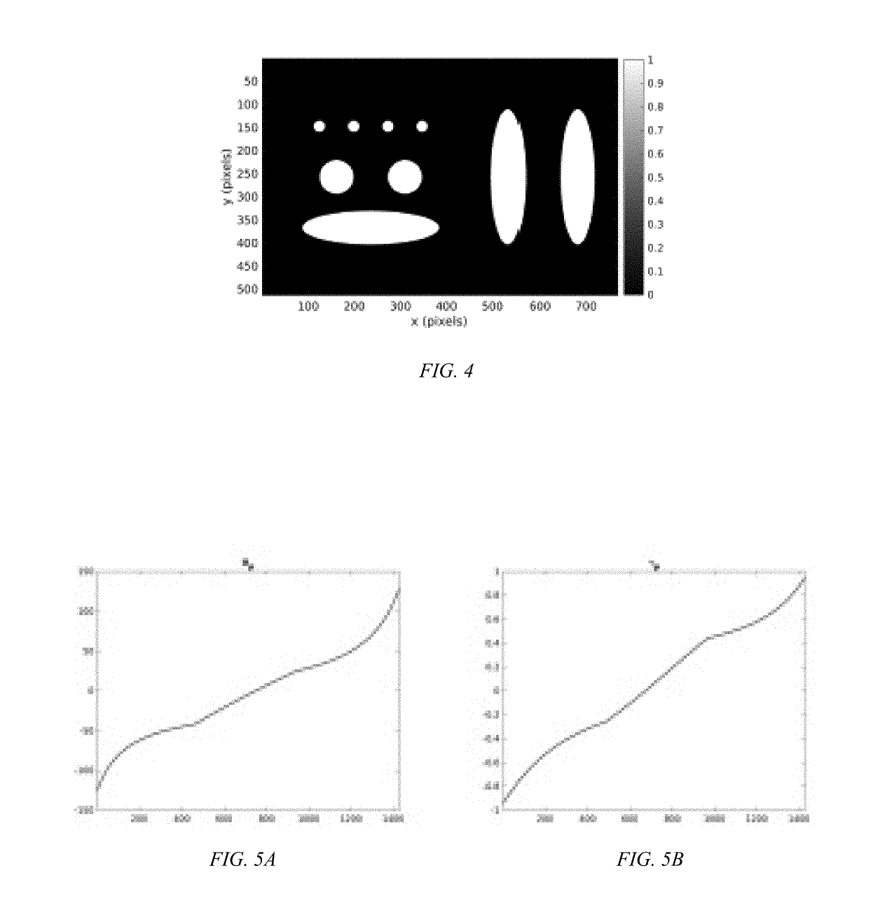

Ideally, the best detector surface is the one that makes the projected detector pixels equispaced on the virtual detector. On the other hand, none of the surfaces that lead to convolution filtering can create uniform grid data without interpolation (see FIG. 5 and the discussion below). As a result, the accuracy of the reconstruction with any given detector heavily relies on the performance of the interpolator.

With a virtual flat detector, there is no restriction on the total range of the uniform grid. The reason is that in this case the filtering step uses convolution with the Hilbert kernel on the line, 1/u (cf. (20)). Based on our numerical experiments, the optimal uniform grid stepsize is obtained from the condition that over the projected ROI range, the number of uniform grid points and the number of the original, projected data points N_{eff} are equal. Introducing the truncated ramp kernel on the virtual circular detector also allows us to select the uniform grid with the optimal stepsize, which reduces interpolation errors. This can be seen by comparing FIG. 11 (optimal stepsize, lower RMSE) and 10 (stepsize smaller than optimal, higher RMSE).

As can be seen from FIG. 7, the flat virtual detector with sharp transition generates worst artifacts. This appears to be due to the highly non-uniform spacing between the projected data points. The spacing is small in the middle of the projected ROI, and is quite large at the edges of the projected ROI. One can visually compare the uniformness of the projected data points by plotting detector coordinates of the projected points on a graph. FIGS. 5(a) and 5(b) show the u(flat virtual detector) and π-coordinates (circular virtual detector) of the projected data points. The data points projected onto the circular virtual detector are closer to a straight line, which implies that the projected data points are more evenly spaced. From this perspective, the circular virtual detector is expected to provide the best result since the projected data points are more uniformly distributed on the virtual detector. However, another factor shows up which leads to a reduction of image quality.

By comparing the error image in FIGS. 9 and 11, one can see that the reconstructed image based on the circular virtual detector has higher resolution (sharper boundaries) than the one based on the flat detector, even though the same number of data points on the projected ROI is used in both cases. In the circular detector case, filtering is done in the frequency domain via the multiplication with the ramp kernel. In the flat detector case, filtering consists of the central difference derivative in the spatial domain followed by Hilbert filtering in the frequency domain. Thus, the circular virtual detector approach better preserves high frequency information, which improves spatial resolution, but also increases streaks. Even though the reconstruction near the edges is more accurate with the circular detector, the streaks are stronger and, consequently, the RMSE error is higher than with the flat virtual detector with smooth transition.

There is another factor that needs to be mentioned. Since parameters of the uniform grid are different for each source position (as opposed to conventional rotating gantry based CT), the ramp kernel needs to be computed for each source. The operation complexity of computing the ramp kernel in (33) is O(N²), which makes the circular virtual detector method much slower than the flat virtual detector methods (unless the filter is precomputed). In the flat detector case, computation of the Hilbert kernel does not involve numerical integration and is much faster. Considering the computational cost and overall accuracy, it appears that the flat virtual detector with smooth transition is the best choice.

FFT is an essential part of analytic CT reconstruction that speeds up the inversion process considerably. Therefore, enabling FFT with non-uniform data is very important. Those methods are called non-uniform FFT (NUFFT).

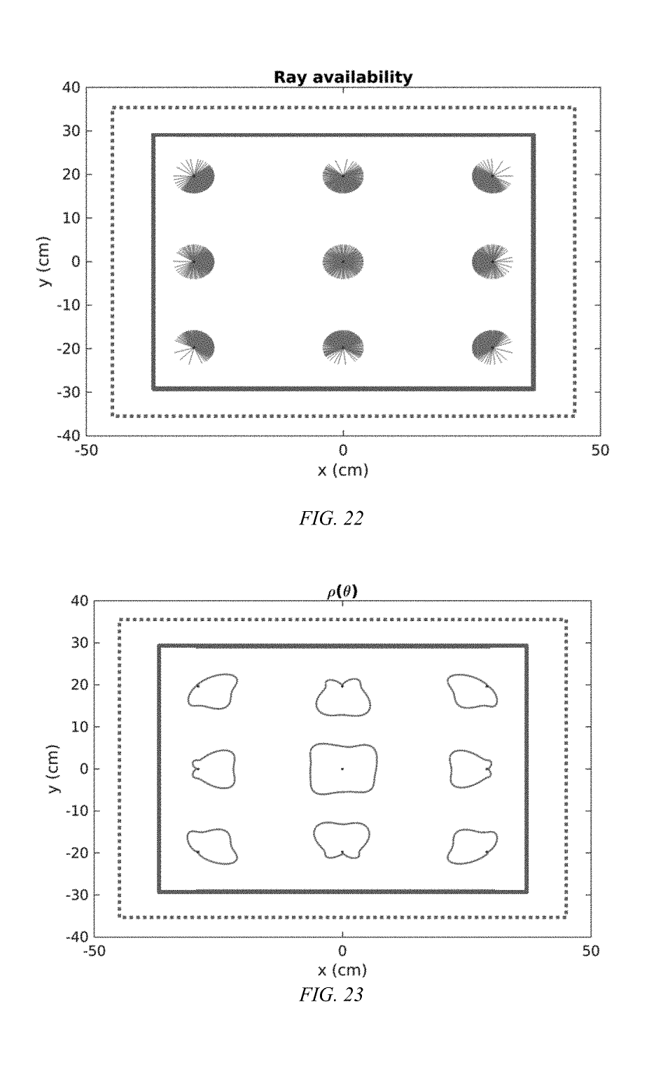

FIG. 22-FIG. 41 illustrate reconstruction results of an additional exemplary embodiment for 3D reconstruction using the NVD algorithm and associated weighting function of the present invention. In this exemplary embodiment, FDK 3D image reconstruction for Stationary Gantry CT is performed with the no-view-differentiation (NVD) algorithm using a three-pass process.

This exemplary embodiment assumes rectangular shapes of the source and detector, and x-ray transmission that is monoenergetic, exhibits no scatter and is noiseless. Additionally, each ray is assumed to be an average of 5×5 pencil beams over each detector pixel. Two phantoms, cylinders (2D) and ellipsoids (3D), having a unit attenuation coefficient are considered in the exemplary reconstruction.

In the first pass, image pixels are projected onto the physical detectors. 2D projection information is provided and the source availability for each image pixel is then stored in an array.

In the second pass, use the source availability data stored in the first pass to compute the angular Gaussian mixture density for each pixel location and compute the weighting function using the following formula:

w(\vec{x},s)=ρⁿ(\vec{x},s)/(ρⁿ(\vec{x},s)+ρⁿ(\vec{x},s*)), (43)

where s* is the pi-partner of s, as previously illustrated in FIG. 3.

In a third pass, the FDK, cosine-weighted, 1D-filtered, 3D-back-projection is performed on the flat virtual detector domain, wherein the back-projection for each view is weighted based upon the source availability and the weighting function stored in the array during the first and second pass.

The ray availability in nine different image locations, plotted as radial distance along the ray angle centered at each image location, is illustrated in FIG. 22 and the Gaussian mixture density is illustrated in FIG. 23, wherein:

$$ρ ( \vec{x} , s ) = {\sum }_{m} exp ( - \frac{{( θ ( m ) - θ ( s ) )}^{2}}{2 {σ}^{2}} ) . \qquad ( 44 )$$

FIG. 24 illustrates the weight function, wherein:

w(\vec{x},s)=ρⁿ(\vec{x},s)/(ρⁿ(\vec{x},s)+ρⁿ(\vec{x},s*)),n=3,

w(\vec{x},s)+w(\vec{x},s*)=1(normalization condition). (45)

FIG. 25a-FIG. 25d illustrate the weight function for image slices with different z values, wherein for FIG. 25a, z=0, for FIG. 25b, z=0.3, for FIG. 25c, z=0.4 and for FIG. 25d, z=0.5. As shown, the weight function does not vary significantly along z and as such, the averaged weight along z may be good for every slice.
The invented method incorporating a weighting function may be represented as follows:

$$f ( \vec{x} ) = \frac{1}{2 π} {\int }_{S} ( \frac{\partial }{\partial s} \frac{w ( \vec{x} , s )}{\vert \vec{x} - \vec{y} ( s ) \vert} ) {\int }_{0}^{2 π} \frac{\hat{f} ( \vec{y} ( s ) , γ )}{sin ( γ - θ ( \vec{x} , s ) )} d γ ds + \frac{1}{2 π} {\int }_{S} \frac{w ( \vec{x} , s ) \vert {\vec{y}}^{′} ( s ) \times ( \vec{x} - \vec{y} ( s ) ) \vert}{{\vert \vec{x} - \vec{y} ( s ) \vert}^{3}} {\int }_{0}^{2 π} \frac{{\partial }_{γ} \hat{f} ( \vec{y} ( s ) , γ )}{sin ( γ - θ ( \vec{x} , s ) )} d γ ds . \qquad ( 46 )$$

Wherein, one ramp kernel plus one Hilbert kernel convolution (that can be applied e.g., in the frequency domain) are multiplied by some weights. Each of the integrals with respect to y is a filtering step, and each of the integrals with respect to s is a backprojection step. The overall algorithm is of the Filtered Back-Projection (type): filtering is followed by backprojection.

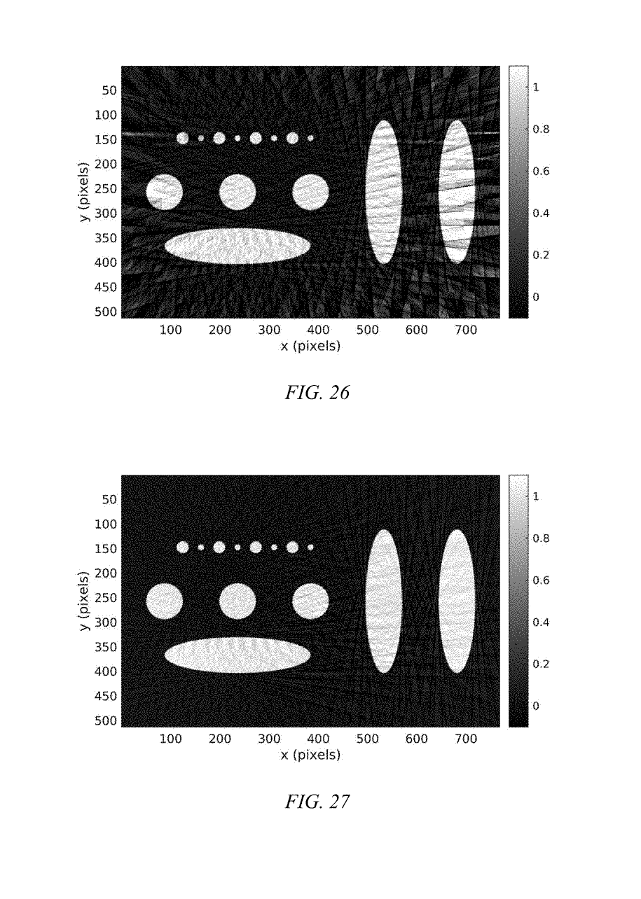

Cylindrical phantom reconstruction results using the same data are illustrated in FIG. 26 and FIG. 27, wherein the results in FIG. 26 are based on the previous algorithms and the results in FIG. 27 are based on the improved NVD algorithm of the present invention. As shown, the improved algorithm reduces the streak artifact, which is caused by the irregular angular availability pattern, without losing resolution.

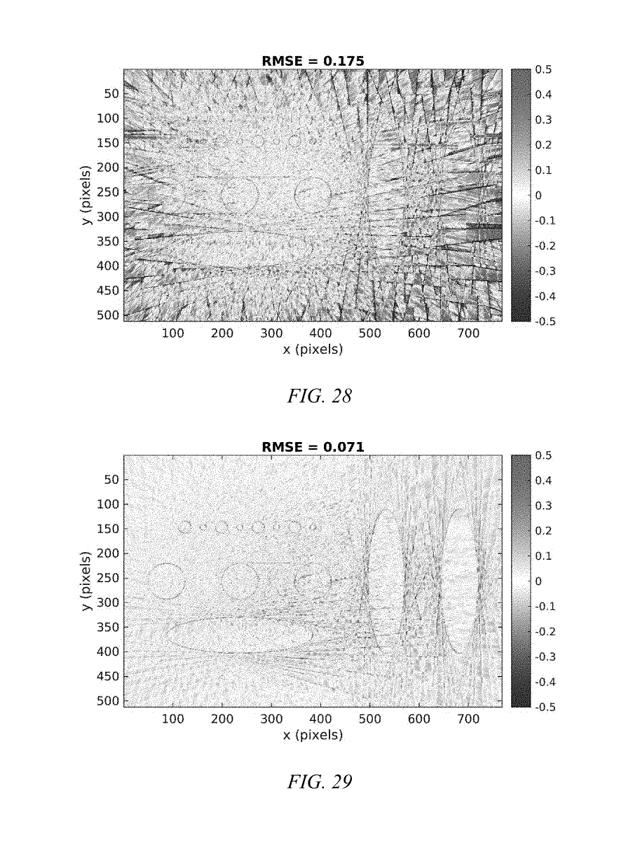

The error map of the reconstruction results of FIG. 26 is shown in FIG. 28 and the error map of the reconstruction results of FIG. 27 is shown in FIG. 29. As shown, the method of the present invention results in a 60% reduction of the streak artifact error (RMSE).

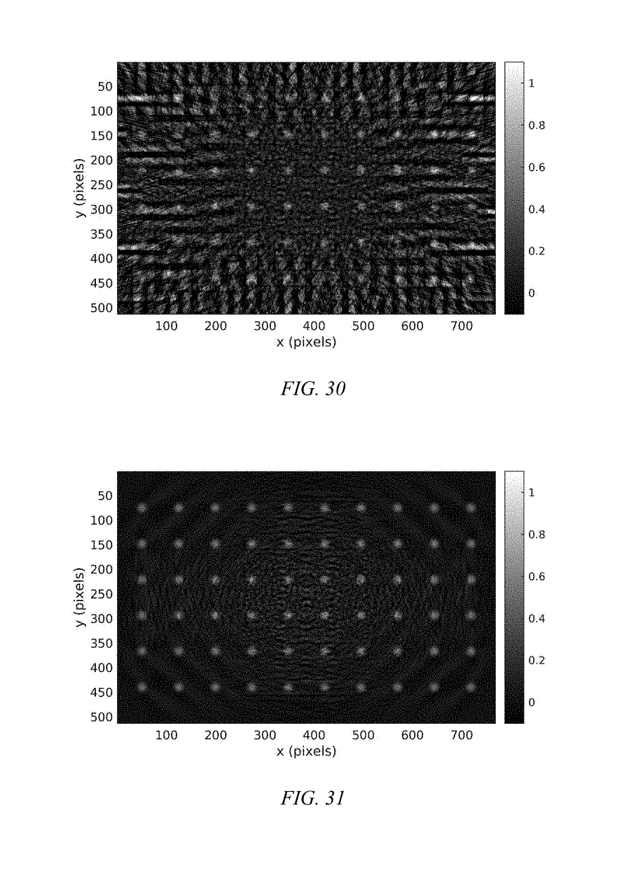

Ellipsoids phantom reconstruction results using the same data are illustrated in FIG. 30 and FIG. 31 for z=0.5, wherein the results in FIG. 30 are based on the previous algorithms and the results in FIG. 31 are based on the improved NVD algorithm of the present invention. As shown, as the streak artifacts are reduced, the cone beam artifact becomes visible.

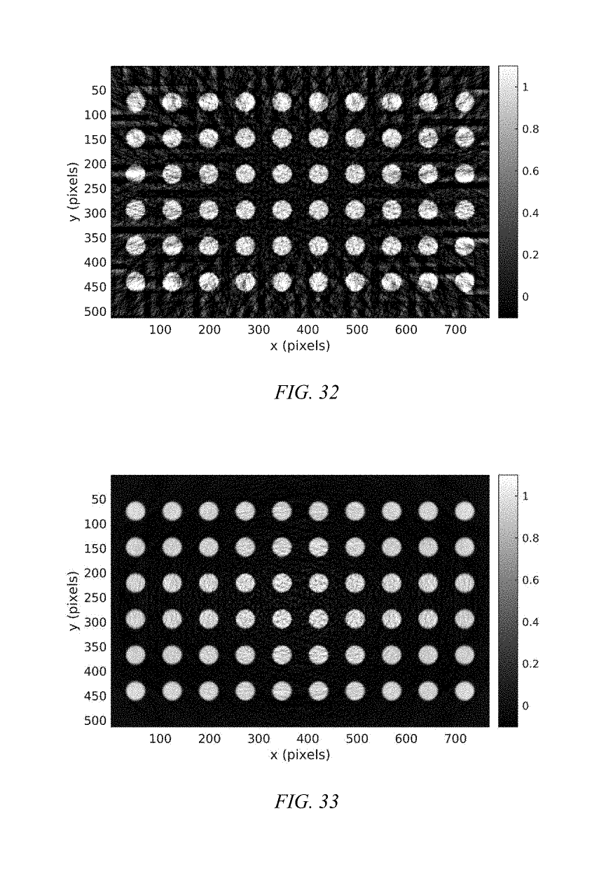

Ellipsoids phantom reconstruction results using the same data are illustrated in FIG. 32 and FIG. 33 for z=0.3, wherein the results in FIG. 32 are based on the previous algorithms and the results in FIG. 33 are based on the improved NVD algorithm of the present invention.

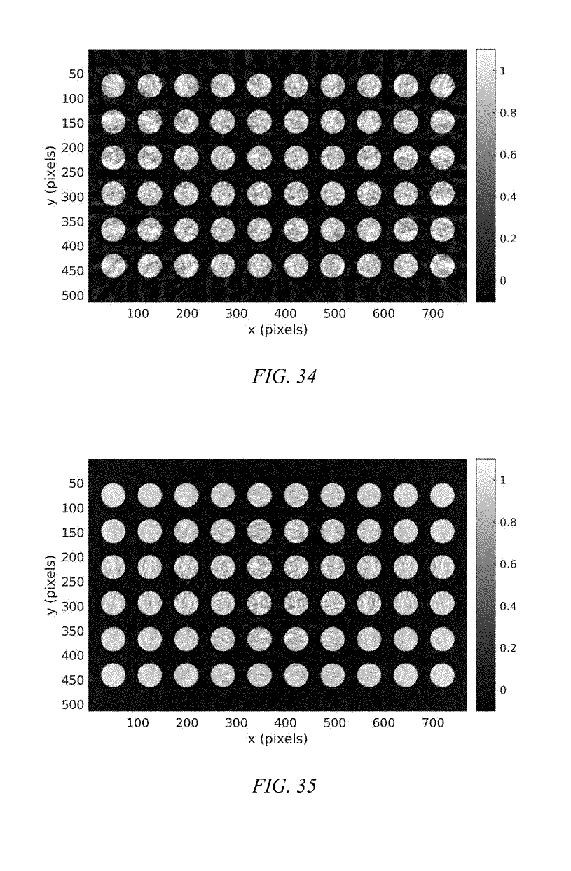

Ellipsoids phantom reconstruction results using the same data are illustrated in FIG. 34 and FIG. 35 for z=0, wherein the results in FIG. 34 are based on the previous algorithms and the results in FIG. 35 are based on the improved NVD algorithm of the present invention.

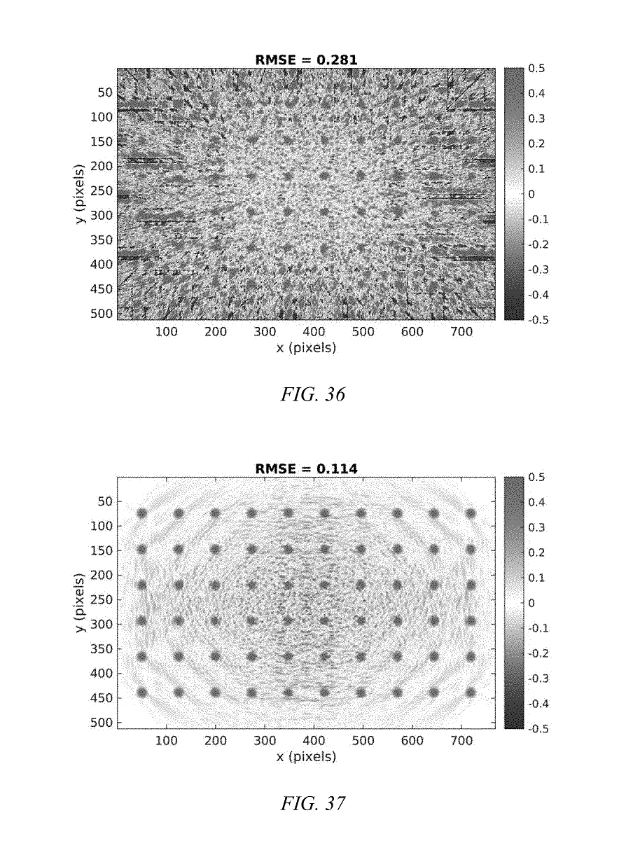

The error map of the reconstruction results of FIG. 30 is shown in FIG. 36 and the error map of the reconstruction results of FIG. 31 are shown in FIG. 37, for z=0.5. As shown, the method of the present invention results in a 60% reduction of the streak artifact error (RMSE) and the cone beam artifact, consisting of a low frequency circular halo and stripes, is visible after the streak artifact has been reduced.

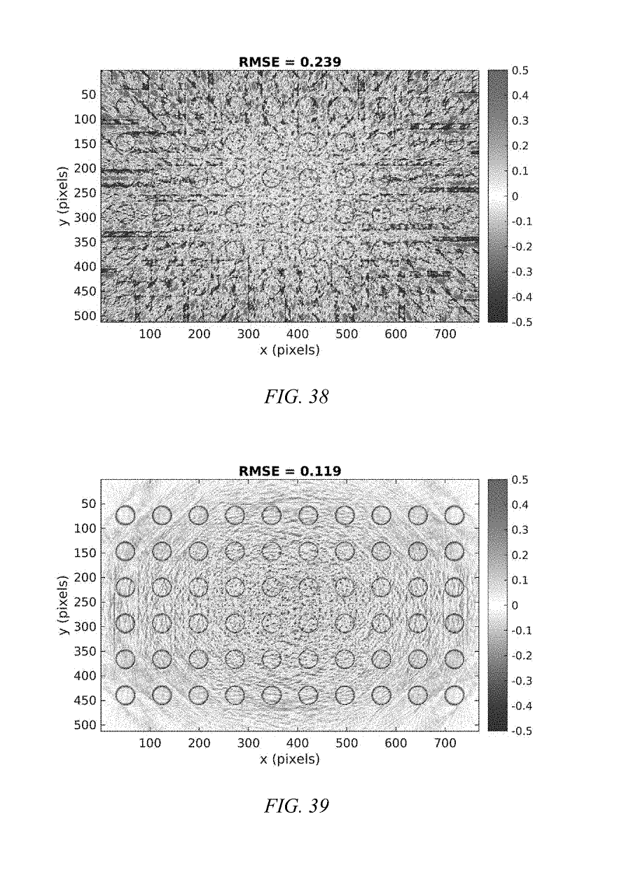

The error map of the reconstruction results of FIG. 32 is shown in FIG. 38 and the error map of the reconstruction results of FIG. 33 are shown in FIG. 39, for z=0.3. As shown, the method of the present invention results in a 50% reduction of the streak artifact error (RMSE) and the cone beam artifact, away from the top of the ellipsoids, consists mostly of a low frequency circular halo.

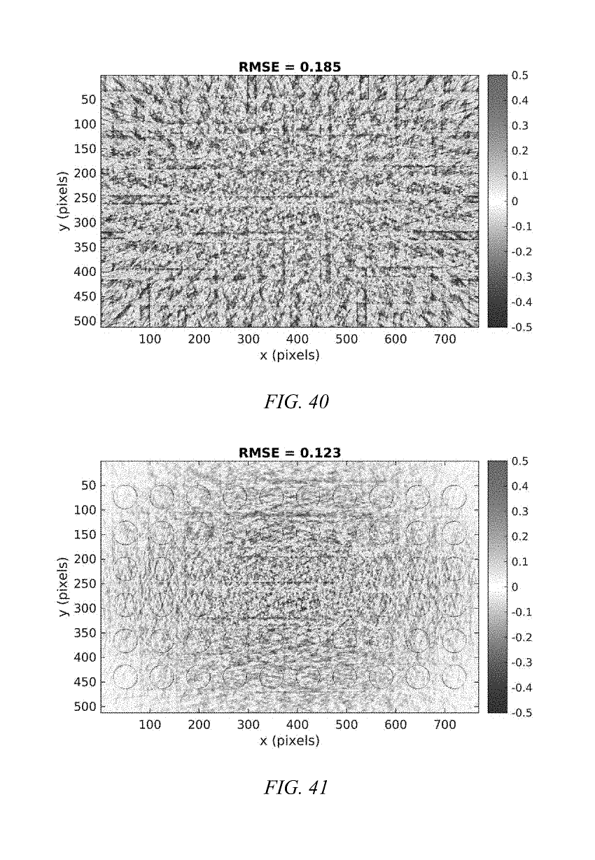

The error map of the reconstruction results of FIG. 34 is shown in FIG. 40 and the error map of the reconstruction results of FIG. 35 are shown in FIG. 41, for z=0. As shown, the method of the present invention results in a 34% reduction of the streak artifact error (RMSE) and the cone beam artifact, away from the top of the ellipsoids, consists mostly of a low frequency circular halo.

As illustrated by the exemplary embodiment, implementation of the new formula with optimized weighting results in significant reduction of streaks cased by angular undersampling.

In various embodiments, the present invention provides a new image reconstruction NVD algorithm, which can be applied to the SGCT-type systems. We also present a family of reconstruction algorithms, which involve a fairly flexible weight function. Even though these algorithms use view differentiation, integrating by parts we can obtain their mathematically equivalent formulations that are of the NVD type. The SGCT system has features that are typically not present in more conventional scanners: e.g., non-sequential firing of sources (leading to the absence of “source trajectory” in the conventional sense), stationary detector, relative positions of the source and detector change from one source to the next, etc. Hence, weight optimization can be designed to address SGCT-specific tasks that do not arise with conventional scanners (and, therefore, not anticipated in the state of art in the field). Then we show how any of these 2D algorithms can be extended to reconstruction from cone-beam data, leading to NVD3D and advanced NVD3D algorithms.

The present invention may be embodied on various computing platforms that perform actions responsive to software-based instructions. The following provides an antecedent basis for the information technology that may be utilized to enable the invention.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, The present invention may be embodied on various computing platforms that perform actions responsive to software-based instructions. The following provides an antecedent basis for the information technology that may be utilized to enable the invention.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, radio frequency, etc., or any suitable combination of the foregoing. Computer program code for carrying out operations for aspects of the present invention may be written in any combination of one or more programming languages, including an object oriented programming language such as Java, C#, C++ or the like and conventional procedural programming languages, such as the “C” programming language or similar programming languages.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

What is claimed is:

1. A computer-implemented method for reconstructing images from tomographic cone beam data, the method comprising:
receiving tomographic cone beam data of an object collected by a scanner;
analyzing the tomographic cone beam data at each point of a plurality of reconstruction points, wherein the tomographic cone beam data comprises one or more deficiencies;
selecting a weight function for a non-iterative image reconstruction algorithm that overcomes the one or more deficiencies in the tomographic cone beam data as related to the plurality of reconstruction points; and
applying the non-iterative image reconstruction algorithm using the selected weight function for each of the plurality of reconstruction points to reconstruct the image of the object from the tomographic cone beam data.

2. The method of claim 1, wherein the one or more deficiencies in the tomographic cone beam data are a result of one or more of, irregular view sampling, variation in source noise, variation in local spatial resolution and variation due to non-periodic source trajectory.

3. The method of claim 1, wherein the one or more deficiencies in the tomographic cone beam data are a result of a changing position of an x-ray source of the scanner relative to a position of an x-ray detector of the scanner during a scan of the object.

4. The method of claim 3, wherein the scanner comprises a plurality of stationary x-ray sources and a plurality of stationary x-ray detectors, wherein the plurality of stationary x-ray sources are arranged along a first curve and the plurality of stationary x-ray detectors are arranged along a second curve, wherein at least one of the curves is noncircular and wherein the position of the x-ray source relative to the position of the x-ray detector changes during the scan due to the arrangement of the plurality of stationary x-ray sources and stationary x-ray detectors along the first and second curves.

5. The method of claim 4, wherein the plurality of stationary x-ray sources are fired in a non-sequential order.

6. The method of claim 4, wherein analyzing the tomographic cone beam data further comprises, computing an availability map, wherein the availability map indicates whether each of the plurality of reconstruction points is visible from each of the plurality of stationary x-ray sources.

7. The method of claim 1, wherein the non-iterative image reconstruction algorithm is a Filtered Back-Projection (FBP) reconstruction algorithm.

8. The method of claim 6, wherein selecting a weight function for a non-iterative image reconstruction algorithm that overcomes the one or more deficiencies in the tomographic cone beam data as related to each of the plurality of reconstruction points further comprises, using the availability map to compute a smooth weight function to be used in the non-iterative image reconstruction algorithm for each of the plurality of reconstruction points.

9. An image reconstruction system for reconstructing images from tomographic cone beam data, the system comprising:
at least one data processor for;
receiving tomographic cone beam data of an object collected by a scanner;
analyzing the tomographic cone beam data at each point of a plurality of reconstruction points, wherein the tomographic cone beam data comprises one or more deficiencies;
selecting a weight function for a non-iterative image reconstruction algorithm that overcomes the one or more deficiencies in the tomographic cone beam data as related to the plurality of reconstruction points; and
applying the non-iterative image reconstruction algorithm using the selected weight function for each of the plurality of reconstruction points to reconstruct the image of the object from the tomographic cone beam data.

10. The system of claim 9, further comprising a display for displaying the results of the image reconstruction of the object.

11. The system of claim 9, wherein the one or more deficiencies in the tomographic cone beam data are a result of one or more of, irregular view sampling, variation in source noise, variation in local spatial resolution and variation due to non-periodic source trajectory.

12. The system of claim 9, wherein the one or more deficiencies in the tomographic cone beam data are a result of a changing position of an x-ray source of the scanner relative to a position of an x-ray detector of the scanner during a scan of the object.

13. The system of claim 12, wherein the scanner comprises a plurality of stationary x-ray sources and a plurality of stationary x-ray detectors, wherein the plurality of stationary x-ray sources are arranged along a first curve and the plurality of stationary x-ray detectors are arranged along a second curve, wherein at least one of the curves is noncircular and wherein the position of the x-ray source relative to the position of the x-ray detector changes during the scan due to the arrangement of the plurality of stationary x-ray sources and stationary x-ray detectors along the first and second curves.

14. The system of claim 13, wherein the plurality of stationary x-ray sources are fired in a non-sequential order.

15. The system of claim 13, wherein analyzing the tomographic cone beam data further comprises, computing an availability map, wherein the availability map indicates whether each of the plurality of reconstruction points is visible from each of the plurality of stationary x-ray sources.

16. The system of claim 9, wherein the non-iterative image reconstruction algorithm is a Filtered Back-Projection (FBP) reconstruction algorithm.

17. The system of claim 15, wherein selecting a weight function for a non-iterative image reconstruction algorithm that overcomes the one or more deficiencies in the tomographic cone beam data as related to each of the plurality of reconstruction points further comprises, using the availability map to compute a smooth weight function to be used in the non-iterative image reconstruction algorithm for each of the plurality of reconstruction points.

18. One or more non-transitory computer-readable media having computer-executable instructions for performing a method of running a software program on a computing device for reconstructing images from tomographic cone beam data, the computing device operating under an operating system, the method including issuing instructions from the software program comprising:
receiving tomographic cone beam data of an object collected by a scanner, wherein the scanner comprises a plurality of stationary x-ray sources;
analyzing the tomographic cone beam data at each point of a plurality of reconstruction points, wherein the tomographic cone beam data comprises one or more deficiencies;
selecting a weight function for a non-iterative image reconstruction algorithm that overcomes the one or more deficiencies in the tomographic cone beam data as related to the plurality of reconstruction points; and
applying the non-iterative image reconstruction algorithm using the selected weight function for each of the plurality of reconstruction points to reconstruct the image of the object from the tomographic cone beam data.

19. The media of claim 18, wherein analyzing the tomographic cone beam data further comprises, computing an availability map, wherein the availability map indicates whether each of the plurality of reconstruction points is visible from each of the plurality of stationary x-ray sources.

20. The media of claim 19, wherein selecting a weight function for a non-iterative image reconstruction algorithm that overcomes the one or more deficiencies in the tomographic cone beam data as related to each of the plurality of reconstruction points further comprises, using the availability map to compute a smooth weight function to be used in the non-iterative image reconstruction algorithm for each of the plurality of reconstruction points.
